(19) United States
(12) Patent Application Publication
(10) Pub. No.: US 2024/0239954 A1
(43) Pub. Date: Jul. 18, 2024

(54) POLYESTER COPOLYMER AND COATING COMPOSITIONS THEREFROM HAVING IMPROVED CORROSION RESISTANCE

(71) Applicant: SWIMC LLC, Cleveland, OH (US)

(72) Inventors: Nusrah HUSSAIN, Gibsonia, PA (US); George K. BARTLEY, III, Burgettstown, PA (US); Beverly A. ACCIPITER, Mount Pleasant, PA (US); Brenda E. HOHMAN, Pittsburgh, PA (US); Arthur RIAZZI, Harrison City, PA (US)

(21) Appl. No.: 18/561,973

(22) PCT Filed: May 26, 2022
(86) PCT No.: PCT/US2022/072579

§ 371 Date: Nov. 17, 2023

Related U.S. Application Data
(60) Provisional application No. 63/202,078, filed on May 26, 2021.

(51) Int. Cl. C08G 63/42; C08G 63/78; C09D 5/08; C09D 167/04

(52) U.S. Cl. CPC C08G 63/42; C08G 63/78; C09D 5/08; C09D 167/04; C08G 2150/90; C08G 2650/36

(57) ABSTRACT

A polyester copolymer useful for food and beverage container coatings is disclosed. The copolymer is derived from ingredients including at least a diepoxide, such as a diglycidyl ether, and a glass transition increasing monomer, such as a pentaspiroglycol. In some approaches, the polyester copolymer is derived from reaction of a polyester prepolymer and a diepoxide resin.

### TECHNICAL FIELD

This invention relates to a polymer, as well as coating compositions, coated metal substrates, and coated metal articles containing the polymer, and a method of making a coated metal substrate.

### BACKGROUND

Polymer coatings have long been used to coat the surfaces of metal food and beverage containers. Coatings are typically applied to the interior of such containers to prevent the contents from contacting the metal of the container. Direct contact between the metal and packaged good can result in corrosion of the metal container, which can contaminate the packaged good. Some packaged food and beverage goods are particularly aggressive degraders of metals and coatings. For instance, acidic foods and some beverages tend to aggressively challenge the physical and chemical protection performance of coatings.

Coatings for metal food and beverage containers must exhibit a preferable combination of characteristics allowing for ease of processing, appropriate physical properties, as well as chemical properties. Container coatings should be capable of high-speed application to the substrate and, when suitably cured, be resistant to coating defects like popping, blistering, and crazing. The coating must maintain adequate adhesion to the metal substrate throughout the lifecycle of the food/beverage container, and also must present sufficient flexibility to allow for processing of the coating into a coated food and beverage container, as well as resist damage from accidental drops and other physical impacts. These characteristics must be maintained throughout processing of the coating into a coated food or beverage container. The coating must be safe for food contact and not adversely impact the taste of the packaged product. The coating must also resist chemical degradation by aggressive food and beverage products packaged in the container. Food and beverage products also may be cooked in the finished coated metal can. Consequently, the coating is preferably able to maintain these mechanical and chemical characteristics at an elevated temperature for an extended time. In addition, shelf-life requirements of packaged food and beverage products may be several years. During shelf-life, the packaged container may encounter several different, harsh environments, including high and low temperatures.

### SUMMARY OF THE INVENTION

In one aspect, the present disclosure provides a polyester copolymer preferably having hydroxyl groups pendant to the backbone of the polymer, wherein the polyester copolymer is derived from reactants comprising a glass-transition-temperature (Tg)-increasing monomer such as, e.g., a pentaspiroglycol, and a backbone-reactivity increasing monomer such as, e.g., a diglycidyl ether, preferably a diglycidyl ether of tetramethyl bisphenol F or another cyclic-group-containing diol. In preferred embodiments, the polyester copolymer is a polyester-ether copolymer, which is preferably a polyester-ether block copolymer formed by reacting a polyester prepolymer with a diepoxide resin, more preferably a diglycidyl ether of a cyclic-group-containing diol. That is, in preferred embodiments, the backbone-reactivity increasing monomer is preferably a diepoxide, more preferably a diglycidyl ether, or a cyclic-group-containing diol.

In another aspect, the present disclosure provides a coated metal substrate comprising a metal substrate and a coating on at least a portion of the substrate, wherein the coating is formed from a coating composition of the present disclosure.

In another aspect, the present disclosure provides a method of making a coated metal substrate comprising providing a metal substrate, applying a coating composition of the present disclosure on at least a portion of the metal substrate prior to or after forming the metal substrate into a food or beverage container or a portion of a food or beverage container; and curing the coating composition to form a coating.

In another aspect, the present disclosure provides for a coated metal article comprising a metal substrate and a coating formed from the coating composition of the present disclosure, wherein the coated metal article is suitable for use as a food or beverage container or a portion thereof, or in forming such an article.

As described herein, the polyester copolymer of the present disclosure may be incorporated into a coating composition useful for coating a wide variety of articles, such as metals formed into, or for use in forming, metal packaging articles. Preferred coating compositions of the present disclosure are particularly useful for coating metal food or beverage containers (e.g., cans) or portions thereof, including applications in which the coating is in contact with a food or beverage product, such as when the coating is applied to the interior of the coated metal article. The coating composition typically includes the polyester copolymer of the present disclosure (preferably in a film-forming amount), an optional crosslinker, and an optional liquid carrier. In a currently preferred embodiment, the coating composition includes at least one phenolic crosslinker. Nonetheless, in some embodiments, the coating composition of the present disclosure is free of formaldehyde-containing ingredients. In some embodiments, the polyester copolymer of the present disclosure may be self-crosslinking.

The disclosure provided in the summary of the invention optionally may be combined with one or more features as further described herein.

The above summary of the present disclosure is not intended to describe each disclosed embodiment or ever implementation of the present disclosure. The description that follows more particularly exemplifies illustrative embodiments. In several places in the application, guidance is provided through lists of examples, which examples can be used in various combinations. In each instance, the recited list serves only as a representative group and should not be interpreted as an exhaustive list.

The details of one or more embodiments of the present disclosure are set forth in the description below. Other features, objects, and advantages of the invention will be apparent from the description below and the claims.

### Definitions

As used herein, “a,” “an,” “the,” “at least one,” and “one or more” are used interchangeably. Thus, for example, an additive that includes “a” structural unit means that the additive may include “one or more” structural units.

The term “on,” in the context of a coating applied on a surface or substrate, includes both coatings applied directly or indirectly to the surface or substrate. Thus, for example, a coating applied to a primer layer overlaying a substrate constitutes a coating applied on the substrate. In comparison, “directly on,” in the context of a coating applied directly on a surface or substrate, refers to the coating in direct contact with the surface or substrate without the presence of any intermediate layers or coatings therebetween.

The term “substantially free” when used with respect to a coating composition, coating, polymer or material that may contain a particular compound means that the coating composition or coating contains less than 1,000 parts per million (ppm) of the recited compound by weight (corresponding to less than 0.1 wt. %), regardless of the context of the compound (e.g., whether the compound is mobile in the coating composition or bound to a constituent of the coating—e.g., as a structural unit thereof). The term “essentially free” when used with respect to a coating composition, coating, polymer, or material that may contain a particular compound means that the coating composition or coating contains less than 100 parts per million (ppm) of the recited compound by weight, regardless of the context of the compound. The term “essentially completely free” when used with respect to a coating composition, coating, polymer, or material that may contain a particular compound means that the coating composition, coating, or material contains less than 5 parts per million (ppm) of the recited compound by weight, regardless of the context of the compound. The term “completely free” when used with respect to a coating composition, coating, polymer, or material that may contain a particular compound means that the coating composition, coating, polymer, or material contains less than 20 parts per billion (ppb) of the recited compound by weight, regardless of the context of the compound. As will be appreciated by persons having skill in the art, the amount of a compound in an ingredient, polymer, formulation or other composition typically may be calculated based on the amounts of starting materials employed and yields obtained when making such ingredient, polymer, formulation, or composition.

When the phrases “free of” (outside the context of the aforementioned phrases), “do not contain,” “does not contain,” “does not include any” and similar phrases are used herein, such phrases are not intended to preclude the presence of trace amounts of the pertinent structure or compound which may be present but were not intentionally used, e.g., due to the presence of environmental contaminants.

The recitation of numerical ranges herein by endpoints include all numbers subsumed within that range (e.g., 1 to 5 includes 1, 1.5, 2, 2.25, 2.75, 3, 3.80, 4, 5, etc.). Furthermore, disclosure of a range includes disclosure of all sub-ranges included within the broader range (e.g., 1 to 5 discloses 1 to 4, 1.5 to 4.5, 4 to 5, etc.).

Unless otherwise indicated, the term “polymer” includes both homopolymers and copolymers (e.g., polymers of two or more structurally different monomers). Similarly, unless otherwise indicated, the use of a term designating a polymer class such as, for example, “polyester” includes both homopolymers and copolymers (e.g., polyester-ether copolymers).

A “container” encompasses containers such as pails or drums or glass jars with or without a top and with or without an opening feature, in addition to conventional cans (e.g., food or beverage cans). It encompasses one-piece, two-piece, and three-piece metal cans. It also encompasses metal cups such as those described in U.S. Pat. No. 10,875,076.

“Pendant to the backbone” of a polymer and “pendant group” means that the identified group is either bonded directly to the backbone of the polymer or is present in a side chain that is itself bonded to the backbone of the polymer (e.g., the identified group is bonded to a small group of atoms such as an aliphatic chain like methylene, ethylene, propylene, etc. that is itself bonded to the backbone of the polymer). For instance, a hydroxyl group is pendant to the backbone of a polymer when the hydroxyl group is a secondary or tertiary alcohol on the backbone of a polymer (e.g., directly attached to a carbon atom present in a non-terminal structural unit of the polymer backbone), or the hydroxyl group is bonded to small group of atoms that is itself bonded to the backbone of the polymer. By way of further example, a terminal primary hydroxy group present in a terminal polymer backbone structural unit derived from, for example, ethylene glycol is not pendant to the backbone, nor is a terminal secondary hydroxyl group present in a terminal backbone structural unit derived from, for example, 2,2,4,4-Tetramethyl-1,3-cyclobutanediol.

As used herein, the term “organosol” refers to a dispersion of thermoplastic particles (e.g., polyvinyl chloride particles) in a liquid carrier that includes an organic solvent or a combination of an organic solvent and a plasticizer.

The term “polycyclic” means a structural unit that includes more than one saturated or unsaturated organic rings (e.g., aliphatic or aromatic), wherein the rings share at least one atom such that the rings are fused, bridged, or spiro with respect to each other. A bicyclic structural unit includes two such organic rings. A tricyclic structural unit includes three such organic rings.

The term “comprises” and variations thereof do not have a limiting meaning where these terms appear in the description and embodiments. Such terms will be understood to imply the inclusion of a stated step or element or group of steps or elements but not the exclusion of any other step or element or group of steps or elements. The term “consisting of” means including, and limited to, whatever follows the phrase “consisting of.” Thus, the phrase “consisting of” indicates that the listed elements are required or mandatory, and that no other elements may be present. The term “consisting essentially of” means including any elements listed after the phrase, as well as other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

### Test Methods

Unless otherwise indicated, the following test methods apply to the present disclosure. Unless otherwise indicated, the following test methods were utilized in preparing the examples disclosed herein.

Glass transition temperature (Tg) may be determined by differential scanning calorimetry (DSC). Samples for differential scanning calorimetry (“DSC”) testing are prepared by the following method. A sample is prepared by first removing volatile materials if necessary. To remove volatile materials, the polymer or composition is applied onto aluminum sheet panels, the panels are then baked in a laboratory electric oven for 20 minutes at 300° F.). (149° ° C., and the sample is allowed to cool to room temperature and the sample is scraped from the panels. To perform DSC, a sample for DSC is weighed into standard sample pans, and analyzed using a standard DSC heat-cool-heat method. Samples are equilibrated at −60° ° C., then heated at 20° C. per minute to 200° ° C., cooled to −60° C., and then heated again at 20° ° C. per minute to 200° C. Glass transition temperatures are calculated from the thermogram of the last heat cycle. The glass transition is measured at the inflection point of the transition.

Iodine value may be determined using ASTM D 5768-02 (Reapproved 2006) entitled “Standard Test Method for Determination of Iodine Values of Tall Oil Fatty Acids.” Iodine values herein are expressed in terms of the centigrams of iodine per gram of the material.

The hydroxyl number (HN) of a resin may be measured by dissolving a suitable quantity of the resin in Methylene Chloride before mixing the sample for 15-20 minutes with a 4-(dimethylamino) pyridine (DMAP) catalyst solution and a 97% acetic anhydride solution in anhydrous dimethyl formamide (DMF). A solution of DMF and deionized water is then added and the solution is mixed for an additional 15-20 minutes. After supplemental addition of tetrahydrofuran (THF), a titration method with 0.5 N methanolic KOH and a phenolphthalein indicator is used to measure the hydroxyl number of a resin. Based on the amount of KOH consumed as compared to titration of a solution without the resin, the hydroxyl number is calculated and reported as mg KOH per 1 g dry resin.

The acid number (AN) of a resin may be measured by dissolving a suitable quantity of the resin in a solution of dimethyl formamide (DMF) and methyl ethyl ketone (MEK), then titrating with 0.1 N methanolic KOH and a cresol red/thymol blue indicator blend. Based on the amount of KOH consumed, the acid number is calculated and reported as mg KOH per 1 gram of dry resin.

The epoxy value (EV) of a resin may be measured by dissolving a suitable quantity of the resin in chlorobenzene at a suitable elevated temperature using a hot plate. 0.2 M Tetrabutylammonium bromide (TBAB) solution in glacial acetic acid is added to the sample and cooled to 38° C. before using a titration method with 0.1 N perchloric acid in acetic acid with electric potentiometric measurement. Based on the volume of titrant required, the epoxy value is calculated and reported as equivalence of epoxy per 100 g dry resin.

Number average molecular weight (Mn) is reported in Daltons (Da), and can be determined by, for example, using gel permeation chromatography (GPC), with a polystyrene standard being used for calibration.

MEK Solvent Resistance: The extent of cure or crosslinking of a coating is measured as a resistance to solvents, specifically methyl ethyl ketone (MEK) or isopropyl alcohol (IPA), and is assessed by the test in ASTMD5402-93. The number of double-rubs (e.g., one back and forth motion) is reported. Preferably, the MEK solvent resistance is at least 30 double rubs.

Dry Adhesion: Adhesion testing assesses whether a coating formed from a composition will adhere to the substrate. Adhesion tests herein are performed according to ASTMD3359-Test Method B, using Scotch 610 tape, available from 3M Company of St. Paul, Minnesota. Adhesion is rated on a scale of 0-10 where 10 indicates no adhesion failure, 9 indicates 90% of the coating remains adhered, 8 indicates 80% of the coating remains adhered, and so on. A cording is considered to satisfy the adhesion test if it exhibits an adhesion rating of at least 8, although values of 9 or 10 are preferred.

Blush Resistance: Blush resistance measures the ability of a coating to resist attack by various solutions. Typically, blush is measured by the amount of water absorbed into a coated film. When a film absorbs water, it generally becomes cloudy or appears white. Blush is measured visually using a scale of 0-10, where a rating of 10 indicates no blush, a rating of 5 indicates slight whitening of the film, and a rating of 0 indicates severe whitening of the film.

Water Retort: Water retort is a measure of the coating integrity of a coated substrate after exposure to heat and pressure with a liquid such as water. Water retort performance is not necessarily required for all food and beverage coatings, but is desirable for some product types that are packed under retort conditions. Testing occurs by subjecting the substrate to heat ranging from 105° C. to 130° C. and pressure of 15 psi (˜1.05 kg/cm2) for a period of 15 to 90 minutes. The coated substrate (after drying with a paper towel) is then tested for adhesion and blush as described above.

Salt retort: Salt retort is a measure of the coating integrity of a coated substrated after exposure to head and pressure while in contact with a salty liquid or material. Salt retort is desirable for food and beverage applications in which the packaged food item contains salt. Testing occurs by subjecting the substrate to the same heat and pressure conditions as water retort; however, the coated substrate remains in contact with a 2% salt solution. The coated substrate (after drying with a paper towel) is then tested for adhesion and blush as described above.

Crazing: Crazing measures the ability of a coating to withstand deformation that may occur when the coated substrate is impacted by a steel punch with a hemispherical head, to assess cracking or adhesion loss. Results are reported on a 0-10 scale with 10 indicating that 100% of the coating remains adhered with no fracturing, and a 0 indicating that 0% of the coating remains adhered with full fracturing, and so on. Crazing is measured according to the method of ASTM D2794-93.

### DETAILED DESCRIPTION

Disclosed are polyester copolymers, suitable for use in a coating, that preferably have hydroxyl groups pendant to the backbone of the polymer. The polyester copolymers are preferably derived from reactants comprising a Tg-increasing monomer and a backbone-reactivity increasing monomer. In preferred embodiments, the polyester prepolymer is formed from ingredients including: (i) a polyester prepolymer preferably including one or more structural units derived from the Tg-increasing monomer and (ii) a backbone-reactivity increasing monomer, which is preferably a diepoxide resin, and optionally includes a structural unit derived from a same or different Tg-increasing monomer.

The disclosed polyester copolymers are suitable for use in a variety of end uses including, for example, as a component of a coating composition applied on a metal substrate such as aluminum or steel. The coating composition may be deposited directly on a metal substrate, or indirectly on a metal substrate such that there is an intermediate layer between the coating formed from the coating composition and the metal substrate. In this way, the coating may be a bottom coat, an intermediate coat, or a topcoat. When used as an intermediate coat or topcoat, the underlying coating may be present on all or only part of a metal substrate or article. Similarly, when used as a bottom coat or intermediate coat, the coating of the present disclosure may be present on only part of the metal substrate or article.

The coated metal substrate may be formed into a coated metal article suitable for use as a food or beverage container (e.g., food cans, beverage cans, and similar) to help protect the metal substrate of the container from corrosion, or metal closures such as metal caps, push-and-twist caps, twist caps, lugs and lug caps, and the like, to protect the food or beverage product from degradation. The coated metal substrate may be used in metal bottles or metal cups such as aluminum cups. The disclosure includes methods of making the coating composition.

The polyester copolymer disclosed herein is suitable for use in a coating composition for coated metal food and beverage containers. Because the disclosed copolymer is so suitable, it also may be suitable for a variety of other applications that may be less demanding.

While not intending to be bound by theory, preferred coating compositions including the copolymer of the present disclosure exhibit a preferred balance of characteristics, which is believed to be the result of an increased number of hydroxyl sites for crosslinking (including at intermediate locations away from the terminal ends of the polymer backbone), together with a composition that increases the glass transition temperature of the polymer. As a result, the coating compositions provide improved adhesion to a metal substrate in challenging environments, like retort, which results in improved resistance to corrosion, as well as improved resistance to crazing and blush, all while maintaining an acceptable blend of properties needed for processing.

Thus, in preferred embodiments, polyester copolymers of the present disclosure have hydroxyl groups pendant to the backbone of the polymer, wherein the polyester copolymer is derived from reactants comprising a Tg-increasing monomer and a backbone-reactivity increasing monomer. The hydroxyl groups pendant to the backbone of the copolymer provide for increased backbone reactivity, thereby allowing for crosslinking at intermediate locations along the copolymer backbone when the copolymer is cured. In preferred embodiments, at least some of the pendant hydroxyl groups are provided by the backbone-reactivity increasing monomer. Diepoxide resins, and particularly diglycidyl ether resins, are preferred backbone-reactivity increasing monomers. Specifically, upon reaction with a suitable group such as, for example, a carboxylic acid group, a diepoxide resin results in one or more hydroxyl groups pendant to the backbone of the resulting polymer. When reacting on each end with a carboxylic acid group the diepoxide resin results in at least two pendant hydroxyl groups.

Preferably, the polyester copolymer of the present disclosure is derived from a polyester prepolymer and a backbone-reactivity increasing monomer that is preferably a diepoxide resin. More preferably, the polyester copolymer is a polyester ether copolymer, and even more preferably a polyester ether block copolymer. Even more preferably, the polyester ether copolymer is derived from a diepoxide resin that is a diglycidyl ether.

When used to formulate an interior food can coating composition, and especially for coatings intended for use in packaging so called “hard-to-hold” products, the polyester polymer preferably exhibits a glass transition temperature (Tg) that is sufficiently high to yield the desired corrosion resistance properties due to reduced softening of the coating during processing and retort. Thus, in the present disclosure, the polyester prepolymer or the diepoxide resin (or both) is derived from a Tg-increasing monomer, which is typically a polyol (e.g., a diol) or a polyacid (e.g., a diacid such as a dicarboxylic acid or anhydride or diester (e.g., dialkyl ester) thereof). A Tg-increasing monomer is a monomer that, if incorporated in the polyester copolymer through a polyacid reactant, includes a polycyclic group (e.g., bicyclic, tricyclic) or a monocyclic group that has less than six members in a ring. A Tg-increasing monomer is a monomer that, if incorporated in the polyester copolymer through a polyol or a diepoxide, comprises a polycyclic group (e.g., bicyclic, tricyclic) or a monocyclic group that has less than six members in a ring, an aromatic group, or a highly branched aliphatic group (e.g., 2,2,4,4-tetramethyl pentane-1,3-diol, 2,2,4,4-tetramethyl pentane-1,5-diol, 2,2,4-trimethyl-1,3-pentanediol). Examples of suitable polycyclic groups include a norbornane group, a norbornene group, an isosorbide group, a naphthalene group, a tricyclodecane group, a spirobicyclic group (e.g., a tetraoxaspiro group), and substituted variants thereof. Examples of suitable monocyclic groups that have less than six members in a ring include furane groups and nadic groups. A highly branched aliphatic group will typically have two or more branch points in the aliphatic structure of the diol and will typically include 20 carbon atoms or less, 15 carbon atoms or less, 10 carbon atoms or less, 9 carbon atoms or less, or 8 carbon atoms or less. Tg-increasing monomers tend to increase the Tg of the polyester copolymer as compared to monomers, such as adipic acid, sebacic acid, ethylene glycol, methylpropanediol, and cyclohexanedimethanol that do not include such groups.

The Tg-increasing monomer preferably may comprise furandicarboxylic acid, preferably 2,5-furandicarboxylic acid, or a diepoxide thereof; or an isosorbide ((3R,3aR,6S,6aR)-Hexahydrofuro[3,2-b]furan-3,6-diol), a substituted variant thereof, or a diepoxide thereof; or a cyclobutanediol, preferably a tetramethyl cyclobutanediol, (e.g., 2,2,4,4-tetramethyl-1,3-cyclobutanediol), a substituted variant thereof, or a diepoxide thereof; or tricyclodecane dimethanol (e.g., 4,8-Bis(hydroxymethyl)tricyclo[5.2.1.02,6]decane), a substituted variant thereof, or a diepoxide thereof; or diglycidyl ether of furandimethanol (preferably 2,5-furandimethanol); or a diglycidyl ether of benzenedimethanol (e.g., 1,2-benzenedimethanol diglycidyl ether), 1,3-benzenedimethanol diglycidyl ether, 1,4-benzenedimethanol diglycidyl ether); or 3,9-bis(1,1-dimethyl-2-hydroxyethyl)-2,4,8,10-tetraoxaspiro[5.5]undecane, or a substituted or unsubstituted pentaspiroglycol, or a diepoxide thereof; or nadic acid, nadic anhydride, a substituted variant thereof (e.g., methyl nadic anhydride or a short chain alkyl nadic anhydride), or a combination thereof; or naphthalene dicarboxylic acid; or a norbornene-containing diol monomer (e.g., a norbornene dimethanol); or a combination thereof. In some embodiments, any combination of two or more, or three or more Tg-increasing monomers may be used in forming the polyester copolymer.

The Tg-increasing monomer preferably may be a substituted or unsubstituted pentaspiroglycol having the following formula.

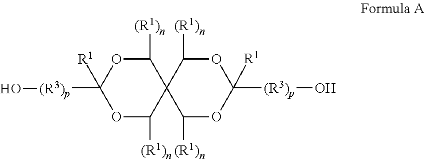

where:
   each R¹ is independently an atom or an organic group;
   the subscript n is independently 1 or 2, where when n is 1 the respective R¹ group is connected by a double bond;
   each R³, if present, is independently a multivalent organic group (e.g., linear or branched), and preferably a hydrocarbon; and
the subscript p is independently 0 or 1 and preferably 1.

Example diols that satisfy Formula A include, but are not limited to, 3,9-bis(1,1-dimethyl-2-hydroxyethyl)-2,4,8,10-tetraoxaspiro[5.5]undecane; 2,4,8,10-tetraoxaspiro[5.5]undecane-3,9-diylbis(2-methylpropane-2,1-diyl) bis[3-[3-(tert-butyl)-4-hydroxy-5-methylphenyl]propanoate]; and the like. In preferred examples, the diols used to prepare the polyester copolymer include 3,9-bis(1,1-dimethyl-2-hydroxyethyl)-2,4,8,10-tetraoxaspiro[5.5]undecane,¹ which has the following structure: ¹ The compound 3,9-bis(1,1-dimethyl-2-hydroxyethyl)-2,4,8,10-tetraoxaspiro[5.5]undecane is often referred to as pentaspiroglycol. However, in the context of the present disclosure, applicants refer to “pentaspiroglycol” to mean a substituted or unsubstituted compound having the structure of Formula A.

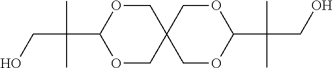 [SMILES: CC(C)(CO)C1OCC2(CO1)COC(C(C)(C)CO)OC2]

or substituted forms thereof. In some embodiments, the diols of Formula A may have a molecular weight of less than about 1,000, less than about 500, or less than about 350 Da, or less than 300 Da.

The polyester prepolymers can be prepared using any suitable synthesis methods, with direct esterification being an example of a preferred synthesis approach. For example, at least one polyfunctional alcohol (“polyol”) and at least one polycarboxylic acid can undergo direct esterification. In some embodiments, a transesterification polymerization may be used (e.g., in addition to, or as an alternative to, direct esterification). For example, a reaction between a terephthalic acid diester and a Tg-increasing monomer diol in the presence of a catalyst can form a polyester prepolymer.

Examples of suitable polyols to make the polyester prepolymers include diols (e.g., any of those disclosed below or anywhere else herein), polyols having three or more hydroxyl groups (e.g., triols, tetraols, etc.), and combinations thereof. In preferred embodiments, at least one of the polyols includes a Tg-increasing monomer (e.g., any of the Tg-increasing diols disclose herein). Suitable polyols (other than the Tg-increasing diols) may include, for example, ethylene glycol, propylene glycol, 1,3-propanediol, 2-methyl-1,3-propanediol, glycerol, diethylene glycol, dipropylene glycol, triethylene glycol, trimethylolpropane, trimethylolethane, tripropylene glycol, neopentyl glycol, pentaerythritol, 1,4-butanediol, 1,6-hexanediol, hexylene glycol, cyclohexanedimethanol, a polyethylene or polypropylene glycol, isopropylidene bis(p-phenylene-oxypropanol-2), and mixtures thereof. If desired, adducts of polyol compounds (e.g., triols, tetraols, etc.) and monofunctional compounds may be used.

Examples of suitable polycarboxylic acids include dicarboxylic acids, polycarboxylic acids having higher acid functionality (e.g., tricarboxylic acids, tetracarboxylic acids, etc.), anhydrides thereof, precursors or derivatives thereof (e.g., an esterifiable derivative of a polycarboxylic acid, such as a dimethyl ester or anhydride), or mixtures thereof. Suitable polycarboxylic acids may include, for example, any of those disclosed elsewhere herein (e.g., any of the Tg-increasing dicarboxylic acid or anhydride monomers disclosed herein), maleic acid, fumaric acid, succinic acid, adipic acid, itaconic acid, phthalic acid, tetrahydrophthalic acid, methyltetrahydrophthalic acid, hexahydrophthalic acid, methylhexahydrophthalic acid, endomethylenetetrahydrophthalic acid, azelaic acid, sebacic acid, isophthalic acid, trimellitic acid, cyclohexane dicarboxylic acid, glutaric acid, dimer fatty acids (e.g., Radiacid 960 dimer fatty acid), anhydrides or derivatives thereof, and mixtures thereof. If desired, adducts of polyacid compounds (e.g., triacids, tetraacids, etc.) and monofunctional compounds may be used. It should be understood that in synthesizing the polyester, the specified acids may be in the form of anhydrides, esters (e.g., alkyl ester), or like equivalent form. For sake of brevity, such compounds are referred to herein as “carboxylic acids” or “dicarboxylic acids” or “polycarboxylic acids.”

It is contemplated that, in certain embodiments, the polyester prepolymer may include some long-chain hydrocarbons having 12 or less carbon atoms such as, for example, sebacic acid. In some embodiments, however, the polyester prepolymer (and preferably also the final polyester copolymer) is appreciably free of fatty acids (e.g., long-chain or very long-chain fatty acids), oils, and/or other long-chain hydrocarbons. It is believed that the use of unsuitable amounts of such materials may impart undesirable off-tastes or odors to packaged food or beverage products that are kept in prolonged contact with the coating compositions of the present disclosure. In certain embodiments, the polyester prepolymer (and preferably also the final polyester copolymer) includes no more than 20 percent by weight (wt-%), no more than 15 wt-%, or no more than 5 wt-%, if any, of fatty acids, oils, or other “long-chain” hydrocarbons (e.g., having 8 or more carbon atoms such as ≥C10, ≥C12, ≥C15, ≥C20, ≥C30), based on the total non-volatile weight of the reactants used to make the polyester.

Any suitable reaction process may be used to make the polyester prepolymers. Suitable such processes include, for example, processes in which polymerization occurs in the presence of a solvent (e.g., organic solution polymerization) such as reflux polymerization processes as well as processes in which polymerization occurs in the absence of added solvent such as melt-blend polymerization processes.

In preferred embodiments, the polyester prepolymer is prepared from ingredients including: (i) one or more polycarboxylic acids, preferably including at least one aromatic acid (e.g., terephthalic acid, furan dicarboxylic acid, and/or isophthalic acid) and (ii) one or more diols (e.g., one or more aliphatic diols and/or alicyclic diols). The polyester prepolymer preferably is derived in part from polymerization or one or more, two or more, three or more, or all of terephthalic acid, isophthalic acid, 2-Methyl-2,4-pentanediol (MPDIOL), or Cyclohexanedimethanol (CHDM). One or more of the Tg-increasing monomer preferably also is used to derive the polyester prepolymer. Typically, the Tg-increasing monomer used in preparing the polyester prepolymer is a diacid (or alkyl ester thereof or an anhydride) or a diol. Preferably, the polyester prepolymer is derived from reactants including a monomer having an anhydride structural unit. Preferably, polyester prepolymer is derived from reactants including phthalic anhydride, maleic anhydride, or a nadic anhydride.

To increase reactivity with a diepoxide, the ends of the polyester prepolymer preferably are terminated by carboxyl groups. Carboxyl group chain end termination may be achieved through adjustment of the relative ratio of monomers (e.g., stoichiometries of polyacids relative to polyols) used to polymerize the polyester prepolymer. Carboxyl group chain end termination also may be achieved by reacting the polymerized monomers with suitable compounds to end-terminate the polyester prepolymer with carboxylic acid groups. Carboxylic acid chain end termination also may be achieved by inclusion of monomers having carboxylic acid groups. Care is preferably exercised in selecting a reactant and reaction conditions to generate carboxylic acid group chain end termination without unsuitably building molecular weight of the polyester prepolymer. In a preferred embodiment, an anhydride is a preferred compound used as a reactant to generate carboxylic acid ends. The resulting polyester prepolymer preferably is terminated on one end or on both ends of the backbone by a carboxyl group. Preferably, the polyester prepolymer is terminated on at least one end of the backbone by a carboxyl group. More preferably, the polyester prepolymer is terminated at both ends of the backbone by carboxyl groups.

Preferably, the polyester prepolymer is at least partially unsaturated, although in some embodiments it is a saturated prepolymer. While not intending to be bound by theory, it is believed that the presence of certain non-aromatic carbon-carbon double bonds (e.g., those present in structural units derived from monomers having strained unsaturated ring groups such as, e.g., in nadic anhydride) can beneficially contribute to crosslinking. Iodine value is a useful measure for characterizing the number of non-aromatic double bonds present in a material. Iodine values are typically expressed in terms of centigrams of iodine per gram of resin and may be determined using the method provided in the Test Methods section. Preferably, the polyester prepolymer has an iodine level of at least 5, at least 10, at least 20, or at least 50 centigrams of iodine per gram of resin.

Depending on the stoichiometry, type of monomers used, and reaction conditions, the polyester prepolymer may have a variety of molecular weights. The polyester prepolymer preferably has a number average molecular weight (Mn) of at least about 400, at least about 750, at least about 1250, or at least about 1800. The polyester prepolymer preferably has an Mn of less than about 7000, less than about 5000, less than about 3500, or less than about 2500.

Depending on the stoichiometry, type of monomers used, and reaction conditions, the polyester prepolymer may have an elevated glass transition temperature compared to polyester prepolymers that do not include a glass transition increasing monomer. The polyester prepolymer preferably has a glass transition temperature (Tg) of at least 30° C., at least 50° C., at least 60° C., or at least 70° C.

The polyester prepolymer preferably has an acid number of at least 10, at least 20, at least 30, or at least 40 mg KOH/g of resin. In presently preferred embodiments, the acid number of the polyester prepolymer is at least about 30 or at least about 40 mg KOH/g resin. Preferably, the acid number of the polyester prepolymer is less than 300, less than 200, preferably less than 100, and, in certain preferred embodiments, less than 75, or less than 60 mg KOH/g resin.

While not intending to be bound by theory, it is believed that hydroxyl groups pendent to the backbone (e.g., at intermediate locations along the polymer backbone) can provide better crosslinking (e.g., as indicated by a higher number of MEK double rubs), and thus enhanced coating properties. Thus, the polyester copolymer also is derived from a backbone-reactivity increasing monomer (e.g., monomers that provide non-terminal structural units including one or more, preferably two or more hydroxyl groups) to increase the number of hydroxyl groups available for crosslinking. The backbone-reactivity increasing monomer preferably comprises a diepoxide, more preferably a diglycidyl ether, with or without a tetramethyl bisphenol F (TMBPF) structural unit. Preferably, the diepoxide resin includes a TMBPF structural unit. Examples of suitable diepoxide resins include diepoxides of: tricyclodecane dimethanol, tetra methyl cyclobutanediol, furan dimethanol, isosorbide, or 3,9-bis(1,1-dimethyl-2-hydroxyethyl)-2,4,8,10-tetraoxaspiro[5.5]undecane. Examples of suitable diepoxide and diglycidyl ether resins of TMBPF, including methods and materials for making, are described in International Publication No. WO 2017/079437. Other examples of suitable diepoxide resins include diepoxides of polyhydric phenols that are appreciably non-estrogenic, such as those described in U.S. Pat. No. 9,409,219. In embodiments where a high Tg is not critical, other structural units may be present in the dipoxides resins such as those derived from neopentyl glycol (NPG) or cyclohexane dimethanol (CHDM).

In some embodiments, the diepoxide resin is a monomer or oligomer having a weight per epoxide equivalent (WPE) of less than about 500, less than about 300, or less than about 220 grams/epoxy equivalents. WPE values are typically and preferably provided by the manufacturer of an epoxide resin.

In other embodiments, such as when using an upgraded diepoxide resin (e.g., a diepoxide resin formed by upgrading the molecular weight of TMBPF-DGE by reacting with hydroquinone or another suitable diphenol (other than bisphenol A, bisphenol F, or bisphenol S) or other suitable extender for building molecular weight (e.g., a diacid or other diol having epoxy reactive hydroxyl groups), the weight per epoxide equivalent of the epoxide resin may be greater than about 500, greater than about 750, or greater than 1,000 grams/epoxy equivalents. In some such embodiments, the diepoxide resin has pendant hydroxyl groups prior to reaction with the polyester prepolymer or other reactants used to form the polyester copolymer (e.g., when the diepoxide resin is an oligomer or polymer formed via reaction of a diglycidyl ether with a diphenol). While the upper limit is not particularly limited in such embodiments, typically the weight per epoxide equivalent will be less than about 3,000, less than about 2,000, or less than about 1,500.

Preferably, the diepoxide resin is provided by an epoxide component that may be a mixture of monoepoxide, diepoxide, and/or triepoxide components. In some embodiments, the ratio of moles of epoxy groups to the moles of epoxide component is at least 1.2:1 (moles epoxy groups:moles epoxide components), at least 1.6:1, or at least 1.7:1. In some embodiments, the mole ratio of epoxy groups to epoxide component is at most 2.2:1, at most 2.1:1, and at most 2:1.

In some embodiments, the diepoxide resin is derived from a Tg-increasing monomer that includes a polycyclic group or a Tg-increasing monomer with a monocyclic group having six or less, preferably five or less members in the ring. Preferably, the diepoxide resin includes a polycyclic structural group, a mono-cyclic structural group with six or less members in the ring, or a structural unit derived from a diphenol (preferably a bisphenol such as TMBPF or any of the other bisphenols described in U.S. Pat. Nos. 9,409,219). Typically, the cyclic group of such Tg-increasing monomers will be present in the backbone of the diepoxide resin; however, in some embodiments some or all of the cyclic groups may be pendant (e.g., such as those present in the diglycidyl ether of 1-phenyl-1,2-ethanediol or the diglycidyl ether of 2-phenyl-1,2-propanediol). Suitable diepoxide resins may also include any of the diepoxide resins described in U.S. Pat. Nos. 10,793,742, 10,526,277, or U.S. Publ. No. 2019/0345359.

Such a diepoxide may be prepared initially by reacting a diol (e.g., the diol of Formula B or any of the other Tg-increasing monomers disclosed herein that are a diol) with a halohydrin (for example, epichlorohydrin) to form a diepoxide analog (e.g. a diglycidyl ether or “DGE”) with oxirane terminal groups. The resulting epoxide compounds may contain one or more segments of the following formula.

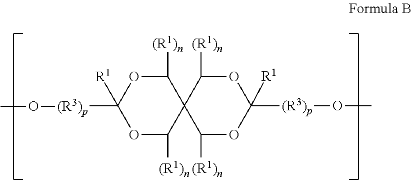

where:
   each R¹ is independently an atom or an organic group;
   the subscript n is independently 1 or 2, where when n is 1 the respective R¹ group is connected by a double bond;
   each R³, if present, is independently a multivalent organic group (e.g., linear or branched), and preferably is a hydrocarbon;
   the subscript p is independently 0 or 1, and preferably 1; and
   optionally, two or more R¹ or R³ groups can join to form a cyclic or polycyclic group.

Upon reaction with the polyester prepolymer, the diepoxide provides hydroxyl (—OH) groups (preferably secondary hydroxyl groups) pendant to the backbone of the resulting polyester copolymer. The polyester copolymer thus preferably includes a plurality of —CH₂—CH(OH)—CH₂— and/or —CH₂— CH₂—CH(OH)— segments within the backbone of the polymer. The polyester copolymer preferably includes a structural unit provided by the diepoxide that is independently joined to adjacent structural units of the copolymer backbone by a CH₂—CH(OH)—CH₂— or a —CH₂— CH₂—CH(OH)— segment. If desired, some or all of the secondary hydroxyl groups may be modified (e.g., using a beta-dicarbonyl compound such as a methyl acetoacetate) to provide a pendant beta-dicarbonyl group using the materials and methods described in U.S. Publ. No. 2020/0095459

The polyester copolymer is preferably generated from an excess of polyester prepolymer as compared to diepoxide resin. In preferred embodiments, the weight ratio of polyester prepolymer used to generate to polyester copolymer to diepoxide resin is at least about 85:1, at least about 10:1, or more than about 1:1.

The polyester copolymer may be of any suitable molecular weight. The Mn of the polyester copolymer preferably is at least about 1,500, preferably at least about 2,500; and is at most about 4,500, or preferably at most about 5,500. While the upper end of suitable molecular weights is not restricted, typically the polyester copolymer will have an Mn of at most about 10,000, at most about 8,000, or at most about 6,000.

The polyester copolymer preferably exhibits a suitable glass transition temperature. The Tg of the polyester copolymer preferably is at least 30° C., at least 40° C., at least 50° C., at least 55° C., at least 60° C., at least 65° C., or at least 70° C. The Tg of the polyester copolymer preferably is at most about 130° C., at most about 100° C., at most about 80° C., at most about 75° ° C., or at most about 70° C.

The polyester copolymer preferably has a hydroxyl number that is relatively elevated as a result of a plurality of hydroxyl groups (more preferably secondary hydroxyl groups) that are pendant to the backbone of the polymer. The polyester copolymer preferably has a hydroxyl number of at least about 1, at least about 5, or at least about 10. The polyester copolymer preferably has a hydroxyl number of at most about 180, at most about 150, or at most about 80. The acid number of the polyester copolymer preferably is at most about 200, at most about 100, or at most about 70. Preferably, for a polyester copolymer suitable for use in a solvent-based coating composition, the acid number is at most 40, at most 30, or at most 20. For a polyester copolymer intended for solvent-based coating compositions, the acid number is preferably as low as possible and, in some embodiments, can be as low as about 0. In some embodiments in which a diepoxide resin is used to form the polyester copolymer, it may be preferable that the polyester copolymer will have an acid number above 0 to ensure that all, or substantially all, of the diepoxide resin has been reacted into the polyester copolymer (e.g., a stoichiometric excess of acid-functional polyester prepolymer is used relative to diepoxide resin). Preferably, for a polyester copolymer suitable for use in an aqueous coating composition, the acid number is at least 15 and at most about 200, more preferably at most 70, and, in some embodiments, at most 40.

The backbone-reactivity increasing monomer preferably is at least about 1, at least about 15, or at least about 30 weight percent of the reactants used to generate the polyester copolymer. The Tg-increasing monomer preferably is at least about 5, at least about 7, at least about 10, or at least about 15 weight percent of the reactants used to generate the polyester copolymer.

In another aspect, the invention is a coating composition that includes the polyester copolymer of the present disclosure, preferably in a film-forming amount. Although coating compositions other than food- or beverage-contact coating compositions are within the scope of this invention, preferred coating compositions of the invention are suitable for use as food- or beverage-contact coatings. It is further contemplated that the coating composition of the present disclosure may have utility in a variety of other coating end uses, including, for example, other packaging coating applications; industrial coating applications such as appliance coatings, holding tanks and bulk storage containers, coatings for interior or exterior steel building products including pipes and valves; HVAC coating applications; coatings for agricultural metal products; wood coatings; and other storage articles or systems.

The coating composition of the invention preferably includes a polyester copolymer of the present disclosure, an optional crosslinker, and an optional liquid carrier. The coating composition preferably also includes a catalyst (such as, e.g., an acid catalyst) to enhance curing and/or crosslinking. The coating composition may also include inorganic additives, lubricants, wetting additives, or defoamers.

Although coating compositions including a liquid carrier such as water or organic solvent are presently preferred, it is contemplated that the polyester copolymer may have utility in other coating application techniques such as, for example, powder coating. The coating composition comprising the polyester copolymer preferably is solvent-based, preferably is water-based, or preferably is a powder coating.

In some embodiments, the coating composition may be a powder composition. In some such embodiments, the coating composition is a powder composition having suitable particle size distributions and morphologies to be applied to metal coil substrate using the application techniques disclosed in U.S. Pat. No. 11,248,127 and International Application Serial No. PCT/US22/30120, entitled “METHODS OF COATING METAL SUBSTRATES AND MAKING METAL PACKAGING, COATED METAL SUBSTRATES, METAL PACKAGING, AND POWDER COATING COMPOSITION SYSTEMS”.

The polyester copolymer of the present disclosure is preferably dispersible in water or aqueous carrier systems including one or more water-miscible organic solvents, or is preferably is dispersible in an organic solvent that is substantially non-aqueous (e.g., includes less than 2% water by weight, if any intentionally-added water is present).

If a liquid carrier is preferred, suitable carriers include carrier liquids such as organic solvents, water, and mixtures thereof. Liquid carriers are selected to provide a dispersion or solution of the polyester copolymer of the present disclosure. Suitable organic solvents include aliphatic hydrocarbons (e.g., mineral spirits, kerosene, naphtha, and the like); aromatic hydrocarbons (e.g, benzene, toluene, xylene, solvent naphtha 100, 150, 200 and the like); alcohols (e.g., ethanol, n-propanol, isopropanol, n-butanol, iso-butanol and the like); ketones (e.g., acetone, 2-butanone, cyclohexanone, methyl aryl ketones, methyl isoamyl ketones and the like); esters (e.g., ethyl acetate, butyl acetate, and the like); glycols (e.g., butyl glycol); glycol ethers (e.g., ethylene glycol monomethyl ester, propylene glycol monomethyl ether, methoxypropanol and the like); glycol esters (e.g., butyl glycol acetate, methoxypropyl acetate and the like), and mixtures thereof.

If a water-based coating composition is desired, the polyester copolymer may be made water-dispersible using any suitable means, including the use of non-ionic water dispersing groups, salt groups (e.g., anionic and/or cationic salt groups), surfactants, or a combination thereof. Preferred water-dispersible polyester copolymers contain a suitable amount of salt-containing (e.g., anionic and/or cationic salt groups) and/or salt-forming groups to facilitate preparation of an aqueous dispersion or solution. Suitable salt-forming groups may include neutralizable groups such as acidic or basic groups. Preferably, an amine (e.g., a primary, secondary, or tertiary amine) may be used to at least partially, or fully, neutralize the polyester copolymer. At least a portion of the salt-forming groups may be neutralized to form salt groups useful for dispersing the polymer into an aqueous carrier. Acidic or basic salt-forming groups may be introduced into the polymer by any suitable method.

Non-limiting examples of anionic salt groups include neutralized acid (e.g., carboxylic acid) or anhydride groups, sulphate groups (—OSO₃⁻), phosphate groups (—OPO₃⁻), quarternary phosphonium groups, and tertiary sulphate groups, and combinations thereof. Non-limiting examples of non-ionic water-dispersing groups include hydrophilic groups such as ethylene oxide groups. Compounds for introducing the aforementioned groups are known in the art.

As is understood in the art, in a liquid based coating composition, the polyester copolymer is mixed with other additives and the carrier, and the percent solids of the coating composition may be adjusted to result in a desired coating thickness in the coating after application and curing on a metal substrate.

The polyester copolymer preferably is at least about 10 weight percent, at least about 20 weight percent, or at least about 50 weight percent of the total resin solids of the coating composition. The polyester copolymer preferably is at most about 75 weight percent, at most about 50 weight percent, or at most about 25 weight percent of the total resin solids of the coating composition.

The crosslinker of the coating composition preferably is an aminoplast, phenoplast (phenolic resin), blocked isocyanate, beta-hydroxyalkyl amide, benzoxazine, carbonyl dicaprolactam, oxazoline, or combinations thereof. Any of the known hydroxyl/acid-reactive curing (i.e., crosslinking) resins can be used as a crosslinker. The choice of particular crosslinker typically depends on the particular end use that is the subject of the formulation.

Phenoplast or phenolic resins include the condensation products of aldehydes with phenols. Formaldehyde and acetaldehyde are preferred aldehydes. Various phenols can be employed such as, for example, phenol, cresol, p-phenylphenol, p-tert-butylphenol, p-tert-amylphenol, and cyclopentylphenol, bisphenols, and polyphenols.

In some embodiments, the crosslinker is an aminoplast resin. Aminoplast resins include, for example, the condensation products of aldehydes such as formaldehyde, acetaldehyde, crotonaldehyde, and benzaldehyde with amino- or amido-group-containing substances such as urea, melamine, and benzoguanamine. Examples of suitable aminoplast resins include benzoguanamine-formaldehyde resins, melamine-formaldehyde resins, esterified melamine-formaldehyde resins, urea-formaldehyde resins, and combinations thereof. Preferably, the crosslinker is a benzoguanamine-formaldehyde crosslinker.

Examples of suitable isocyanate crosslinkers include blocked or non-blocked aliphatic, cycloaliphatic or aromatic di-, tri-, or poly-valent isocyanates, such as hexamethylene diisocyanate (HMDI), cyclohexyl-1,4-diisocyanate and the like, and mixtures thereof. Examples of generally suitable isocyanates for use in such crosslinkers include isomers of isophorone diisocyanate, dicyclohexylmethane diisocyanate, toluene diisocyanate, diphenylmethane diisocyanate, phenylene diisocyanate, tetramethyl xylene diisocyanate, xylylene diisocyanate, and mixtures thereof.

Crosslinkers that may be suitable include, Allnex Netherlands BV. Cymel® 1130, Cymel® 1133, Cymel® 1141, Cymel® 1156, Cymel® 1158, Cymel® 1161, Cymel® 1168, Cymel® 1170, Cymel® 202, Cymel® 203, Cymel® 211, Cymel® 232, Cymel® 235, Cymel® 250, Cymel® 251, Cymel® 254, Cymel® 285-100, Cymel® 303 LF, Cymel® 304, Cymel® 325, Cymel® 325N, Cymel® 327, Cymel® 327-70, Cymel® 328, Cymel® 350, Cymel® 370, Cymel® 370N, Cymel® 3745, Cymel® 385, Cymel® 5010, Cymel®651. Cymel® 651E. Cymel® 659, Cymel® 659E, Cymel® 683, CYMEL® 682E, Cymel® 701, Cymel® MB 98, Cymel® NF 2000A, Cymel® NF3030, Cymel® NF 3041, Cymel® U-1051, Cymel® U-1052-8, Cymel® U-1054, Cymel® U-216-10LF, Cymel® U-216-8, Cymel® U-227-8, Cymel® U-610, Cymel® U-662, Cymel® U-663, Cymel® U-80, Cymel® U-24-BX, Cymel® UB-30-B, Cymel® UB-90-BX, Cymel® UI-19-I, Cymel® UI-20-E, Cymel® UI-27-EI, Cymel® XW-3106, Viacryl® VSC 6273W/44WA, Viacryl® VSC 6276w/44WA, Viacryl® VSC 6800 w/47WA. Other crosslinkers that may be suitable include, from Hexion™, EPIKURE™ Curing Agents 3200, 3202, 3223, 3230, 3233, 3234, 3245, and 3253; EPIKURE™ Curing Agents 3010, 3015, 3030, 3046, 3055, 3061, 3072, and 3090; and EPIKURE™ Curing Agents 3300, 3370, 3378, 3380, 3381, 3382, 3383, 3387, 3388, and 3393.

Other crosslinkers that may be suitable include, from Evonik Industries AG, Vestanat® EP-MF 201, EP-MF 202, EP-MF 203, EP-MF 204, EP-MF 205; Vestanat® T1890 E. L. SN, Vestanat® T 1890 E. Vestanat® T 1890 L, Vestanat® T1890 SN, Bestanat® T1890/100; Vestanat® B 1186 A, Vestanat® B 1481 ND, Vestanat® B 1358/100, Vestanat® B 1042 E, and Vestanat® B 1358A.

Other crosslinkers that may be suitable include those described in: U.S. Pat. Pub. No. 2016/0297994 (Kuo et al.) such as benzoxazine-based phenolic resins, U.S. Pat. Pub. No. 2016/0115347 (Kuo et al.) such as resole curable phenolic resins based on meta-substituted phenol, U.S. Pat. No. 9,598,602 (Kuo et al.) such as a phenolic resin substituted with at least one methylol group, U.S. Pub. No. 2016/0115345 (Kuo et al.) such as a resole phenolic resin containing the residues of an unsubstituted phenol and/or meta-substituted phenol), and U.S. Pat. Pub. No. 2017/0327272 (Chasser et al.) such as a polycarbodiimide. Other suitable crosslinkers include alkanolamide-type curing agents such as beta-hydroxyalkylamide crosslinkers available under the trade names PRIMID XL-552 and PRIMID QM-1260 from EMS-CHEMIE AG. The level of curing agent (viz., crosslinker) used will typically depend on the type of curing agent, the time and temperature of the bake, and the molecular weight of the disclosed polymer in the coating composition. If used, the crosslinker may be present in an amount of up to 50 wt. %, preferably up to 30 wt. %, and more preferably up to 15 wt. % based on the total weight of the resin solids in the coating composition. If used, a crosslinker is preferably present in an amount of at least 0.1 wt. %, more preferably at least 1 wt. %, and even more preferably at least 1.5 wt. % based upon the total resin solids weight.

In some embodiments, the coating compositions of the present disclosure are substantially free of, preferably essentially free of, more preferably completely free of formaldehyde. In such embodiments, preferably no formaldehyde-containing or formaldehyde-derived compounds are used to prepare the coating composition, although trace amounts may be present due to, for example, environmental contamination. For example, a self-crosslinking version of the polyester copolymers may be employed and/or a non-formaldehyde-derived crosslinker such as, for example, a beta-hydroxyalkylamide.

In some embodiments, the coating composition may include an optional catalyst to increase the rate of cure. Examples of catalysts, include, but are not limited to, strong acids (e.g., phosphoric acid, dodecylbenzene sulphonic acid (DDBSA), available as CYCAT 600 from Cytec), methane sulfonic acid (MSA), p-toluene sulfonic acid (pTSA), dinonylnaphthalene disulfonic acid (DNNDSA), and triflic acid); quaternary ammonium compounds; phosphorous compounds; and tin, titanium, and zinc compounds. Specific examples include, but are not limited to, a tetraalkyl ammonium halide, a tetraalkyl or tetraaryl phosphonium iodide or acetate, tin octoate, zinc octoate, triphenylphosphine, and similar catalysts that will be familiar to persons skilled in the art. If used, a catalyst is preferably present in an amount of at least 0.01 wt. %, and more preferably at least 0.1 wt. %, based on the weight of total solids in the coating composition. If used, a catalyst is preferably present in an amount of no greater than 3 wt. %, and more preferably no greater than 1 wt. %, based on the weight of total solids in the coating composition.

Another useful optional ingredient is a lubricant (e.g., a wax), which facilitates manufacture of fabricated metal articles (e.g., container closures and food or beverage can ends) by imparting lubricity to sheets of coated metal substrate. Suitable lubricants include carnauba wax, polyethylene wax, polypropylene wax, Fisher-Tropsch lubricants, or lanolin. Lubricants are included if needed to affect rheology of the compound. Lubricants also are typically necessary to allow for processing of can opening features such as a riveted end. Lubricants also can provide improved abrasion resistance of the deposited coating. Preferably, the lubricant is substantially free of polytetrafluoroethylene (PTFE). More preferably, the lubricant is essentially free of polytetrafluoroethylene (PTFE). More preferably, the lubricant is essentially completely free of polytetrafluoroethylene (PTFE). More preferably, the lubricant is completely free of polytetrafluoroethylene (PTFE). If used, a lubricant is preferably present in the coating composition in an amount of at least 0.1 wt. %, and preferably no greater than 3 wt. percent, no greater than 2 wt. %, and even more preferably no greater than 1 wt. %, based on the total weight of solids in the coating composition.

Another useful optional ingredient is an inorganic additive, such as blanc fixe, titanium dioxide, zinc oxide, or aluminum flake. If used, titanium dioxide is preferably present in the disclosed coating composition in an amount of no greater than 70 wt. percent, more preferably no greater than 50 wt. percent, and even more preferably no greater than 40 wt. percent based on the total weight of solids in the coating composition. If used, aluminum flake is preferably present in the disclosed coating compositions in an amount of no greater than about 20 wt. percent, based on the total weight of solids in the coating composition.

The total amount of solids present in liquid coating compositions of the present disclosure may vary depending upon a variety of factors including, for example, the desired method of application. In some embodiments, the coating composition includes at least about 18, at least about 30, at least about 35, or at least about 40 weight % of solids, based on the total weight of the coating composition. In some embodiments, the coating composition includes less than about 80, less than about 70, or less than about 65 weight percent of solids, based on the total weight of the coating composition. The solids of the coating composition may be outside the above ranges for certain types of applications. For example, for inside spray applications of the coatings compositions, the weight % solids may be as low as about 18 weight percent.

Existing coatings may contain bisphenol-A (“BPA”). Although the balance of scientific data suggests that the use of such compounds in coatings is safe, there is a desire by some to reduce or eliminate the use of certain BPA-based compounds in containers and coatings, and especially those used in food or beverage packaging. The polyester copolymer of the present disclosure (and preferably also the coating composition) preferably is completely free, essentially free, or substantially free of bisphenol-A, including structural units derived therefrom, and is preferably completely free, essentially free, or substantially free of each of bisphenol-F and bisphenol-S. In some embodiments, polyester copolymer of the present disclosure (and preferably also the coating composition) is completely free, essentially free, or substantially free of bisphenol-A, bisphenol-F and/or bisphenol-S.

The disclosed coating compositions may be applied to a substrate either prior to, or after, the substrate is formed into an article such as, for example, a food or beverage container or a portion thereof. For example, in some embodiments the disclosed coating compositions may be applied as a liquid (e.g., via spray application, roll coating application, curtain coating application, etc.) to a metal substrate, e.g., in the form of a metal sheet or coil that is then formed into a container portion (e.g., a can end, a closure, a can sidewall, etc.). In some embodiments, the metal substrate may be in the form of part of a food or beverage container and the coating composition applied thereto and cured. In some such embodiments, the coating compositions may be spray applied to the inner surface or food contact surface of the container and cured using UV or elevated temperature conditions. In some applications, the coating composition may be applied to only a portion, or all, of a surface of a metal substrate. In some applications, the coating composition may be applied to both surfaces of a metal substrate.

The metal substrate is preferably of suitable thickness to form a metal food or beverage container (e.g., can), an aerosol container (e.g., can), a general packaging container (e.g., can), or a closure, e.g., for a glass jar. In some embodiments, the metal substrate preferably has an average thickness of up to 635 microns, more preferably up to 375 microns. Preferably, the metal substrate has an average thickness of at least 125 microns.

In the context of a cured adherent coating being disposed “on” a surface or substrate, both coatings applied directly (e.g., virgin metal or pre-treated metal such as electroplated steel) or indirectly (e.g., on a primer layer) to the surface or substrate are included. Thus, for example, a coating applied to a pre-treatment layer (e.g., formed from a chrome or chrome-free pretreatment) or a primer layer overlying a substrate constitutes a coating applied on (or disposed on) the substrate.

If a steel substrate is used as the metal substrate, the surface treatment may comprise one, two, or more kinds of surface treatments such as zinc plating, tin plating, nickel plating, electrolytic chromate treatment, chromate treatment, and phosphate treatment. If an aluminum substrate is used as the metal substrate, the surface treatment may include an inorganic chemical conversion treatment such as chromic phosphate treatment, zirconium phosphate treatment, or phosphate treatment; an organic/inorganic composite chemical conversion treatment based on a combination of an inorganic chemical conversion treatment with an organic component as exemplified by a water-soluble resin such as an acrylic resin or a phenol resin, and tannic acid; or an application-type treatment based on a combination of a water-soluble resin such as an acrylic resin with a zirconium salt.

In a preferred embodiment, a coated metal substrate is produced by continuous coating of the coating composition on a metal substrate (e.g., onto aluminum or steel) in the form of coil suitable for use in forming food and beverage containers or portions thereof. In a process for coating a metal substrate, the metal coil is positioned at the beginning of the coating line, and the coil is unwound. The metal substrate may optionally be pre-cleaned, optionally pre-treated, optionally primed, and optionally pre-painted prior to coating. Preferably, the metal substrate may be steel, chrome-treated steel, tinplate steel, or tin-free steel.

In coil coating embodiments, and some sheet coating embodiments, the metal substrate may be provided at a fast linear speed, exceeding 200 feet per minute. Preferably the metal substrate is provided at a line speed of at least about 200 feet per minute. More preferably, the metal substrate is provided, and coated, at a line speed of at least about 400 feet per minute. More preferably, the metal substrate is provided, and coated, at a line speed of at least about 600 feet per minute. More preferably, the metal substrate is provided, and coated, at a line speed of at least about 800 feet per minute. More preferably, the metal substrate preferably is provided, and coated, at a line speed of at least about 800 feet per minute. More preferably, the metal substrate preferably is provided, and coated, at a line speed of at least about 1000 feet per minute. The coating composition may be applied to the metal substrate by a roller or an extruder or any other suitable means for applying the coating, such as a sprayer, curtain coater, knife coatings, dip coating, etc. The coating composition may be applied to one or both sides of the metal substrate.

Once coated, the coated coil (or other coated metal substrate) is subjected to a short thermal, ultraviolet, and/or electromagnetic curing cycle, for hardening (e.g., drying and curing) of the coating. If metal coil is the substrate to be coated, curing of the applied coating composition may be conducted, for example, by heating the coated metal substrate over a suitable time period in an oven at a temperature that is elevated compared to ambient temperature. Preferably, the coating composition cures at the desired temperature within an oven dwell time that allows for fast line speed.

The cure conditions for coating compositions of the present disclosure will vary depending upon the method of application and the intended end use. The curing process may be performed at any suitable temperature, including, for example, oven temperatures in the range of from about 100° ° C. to about 300° ° C., and more typically from about 177° C. to about 250° C. If metal coil is the substrate to be coated, curing of the applied coating composition may be conducted, for example, by heating the coated metal substrate over a suitable time period to a peak metal temperature (“PMT”) of preferably greater than about 350ºF (177° C.). More preferably, the coated metal coil is heated for a suitable time period (e.g., about 5 to 900 seconds, more typically about 5 to 30 seconds) to a PMT of at least about 425° F. (218° C.).

The finished coating thickness or weight is defined by the needs of the particular application. Typically, the average dry coating weight is at least 1, at least 2, or at least 3 milligrams per square inch after curing. Typically, the average dry coating weight after curing it at most 20, preferably at most 15 milligrams per square inch. In some embodiments (e.g., coated aluminum coil for beverage can ends), following coating and curing, the coated metal substrate is wound into a coil.

The coating compositions of the present disclosure should preferably be capable of high-speed application to the substrate and provide the necessary properties when hardened to perform in this demanding end use. For example, a coating should have excellent adhesion to the substrate, resist abrasion, staining, and other coating defects such as “popping,” “blushing” or “blistering,” and resist degradation over long periods of time, even when exposed to harsh environments. In addition, the coating preferably should resist “crazing,” a phenomena in which the coating fractures due to a non-uniform surface of the underlying metal substrate. In addition, the coating should preferably be capable of maintaining suitable film integrity during container fabrication and preferably be capable of withstanding the processing conditions that the container may be subjected to during product packaging, including pasteurization and in-packaging cooking.

Coatings comprising the polyester copolymer of the present disclosure may be used in multi-piece steel or aluminum containers, such as two-piece cans and three-piece cans, including on interior and/or exterior surfaces can ends (including, e.g., easy open food and beverage can ends) and/or bodies. Coatings of the current invention may also be used in metal containers, such as single-piece or multi-piece metal cups or plates. In some such embodiments, the coating composition is an organic-solvent-based coating compositions for use in forming a food-contact coating on the side of a metal sheets for forming the sidewall of a three-piece food can.

In some embodiments, the coating of the present disclosure may be used as a topcoat for metal caps such press and twist caps, or lug caps. In some approaches and particularly where the coating is on a metal cap, a topcoat of organosol polyvinyl chloride optionally may be applied over the coating. The topcoat may include other coatings, such as PVC-free topcoats.

In some applications, a metal cap may include a plastisol or other plastic ring or gasket interior to the metal cap to provide for sealing to a metal or glass container. Thus, in some embodiments, a coating formed from the coating composition of the present disclosure may be present to a substrate and a plastisol gasket applied on top of the cured coating.

Polyester copolymers of the present disclosure were prepared and coated on a metal substrate. The coating was found to have adequate processing characteristics for coating on a metal substrate for a food or beverage packaging container, and exhibited improved corrosion resistance when exposed over time to aggressive acidic products. Preferred polyester copolymers of the present disclosure exhibited superior properties relative to comparable polyester copolymers that either (i) do not include a Tg-increasing monomer in the form of a diol and/or (ii) do not include a backbone-reactivity increasing monomer in the form of a diepoxide monomer or other monomer resulting in the incorporation of pendant hydroxyl groups.

### EXAMPLES

The invention is illustrated by the following examples. It is to be understood that the particular examples, materials, amounts, and procedures are to be interpreted broadly in accordance with the scope and spirit of the inventions set forth herein. Unless otherwise indicated, all parts and percentages are by weight, and all chemicals used are commercially available from, among other sources. Sigma-Aldrich. St. Louis, Missouri.

### Example 1: Preparation of an Intermediate Polyester Prepolymer Derived from a 3,9-bis(1,1-dimethyl-2-hydroxyethyl)-2,4,8,10-tetraoxaspiro[5.5]undecane monomer

Cyclohexane-1,4-dimethanol (738.8 grams (“g”) of a 90% solution in water). 2-methyl-1,3-propanediol (219 g), terephthalic acid (158.8 g), isophthalic acid (317.6 g), and dibutyltin oxide (2.4 g) were charged to a 5-liter. 4-neck round bottom flask fitted with a mechanical stirrer, a thermocouple, a packed column (topped with a 3-way adapter, thermometer, and condenser), and a stopper for future additions. The contents of the flask were heated slowly (so that the temperature of the distillate did not exceed 100° C.) to 230° C., and held until the acid number dropped to 3 milligrams (“mg”) KOH/g resin. The temperature was then reduced to 170° C., and nadic anhydride (706.4 g) was added to the flask. Following a 1-hour hold at 170° C., 3,9-bis(1,1-dimethyl-2-hydroxyethyl)-2.4.8,10-tetraoxaspiro[5.5]undecane (available from Perstorp Specialty Chemicals AB., Sweden) (292.2 g) and xylene (139.5 g) were added to the flask, the packed column was removed and replaced with a Dean-Stark trap (topped with a condenser) filled with xylene in preparation for an azeotrope reflux. The temperature was then raised to 200° C. (or as restricted by reflux) and held until the acid number dropped below 10 mg KOH/g resin. At this point, the resin was cooled to 170° C. and cut to 60% Solids with AROMATIC 150 solvent (1321.0 g). The resulting resin was stirred until uniform and discharged. The resulting intermediate prepolymer resin had an acid number of 43.8. Mn of 2.570, and a Tg of 67° C.

### Example 2: Preparation of a Polyester Copolymer from Reaction of a Polyester Prepolymer Derived from a Pentaspiroglycol Monomer and a Diglycidyl Ether Monomer

501.7 grams of the resin from Example 1 was transferred to a 1-liter flask fitted with a mechanical stirrer, a thermocouple, a condenser, and a stopper for sampling or additions. The contents of the flask were heated to 130° C. and Phthalic Anhydride (34.4 g) was added to the flask in three parts with a 20-minute hold between each addition. Following the final addition. AROMATIC 150 (17.6 g) was added to the flask. At this point, the resin was heated to 145° C. and held until the acid number dropped below 47.1 mg KOH/g resin to form the final polyester prepolymer. Tetramethyl-bisphenol-F-diglycidyl ether (36.9 g, prepared according to the method described in U.S. Pat. No. 11,130,835) and tributylamine (1.11 g) were added to the flask, and the contents were heated to 160° C. under a nitrogen atmosphere. After a 3-hour hold at 160° C., cyclohexanone (228.5 g) was added to achieve a 45% solids solution, and the resin was cooled to room temperature. The resulting polyester-ether block copolymer had an Mn of 4,320, a Tg of 75° C.

### Example 3: Coating Compositions

Sample A. A coating composition that includes a polyester derived from a pentaspiroglycol monomer and a diglycidyl ether monomer. An organic-solution-based coating composition was prepared that included 75% by solids weight of the polymer described in Example 2 and 25% by solids weight of Bakelite PF 6470LB phenolic crosslinker, available from Hexion. The coating composition was approximately 39.5% solids.

Comparative Sample B. A coating composition containing a polyester derived from a diglycidyl ether monomer. Cyclohexane-1,4-dimethanol (802.6 g of a 90% solution in water), 2-methyl-1,3-propanediol (371.3 g), terephthalic acid (202.7 g), isophthalic acid (404.9 g), and dibutyltin oxide (2.4 g) were charged to a 5-liter, 4-neck round bottom flask fitted with a mechanical stirrer, a thermocouple, a packed column (topped with a 3-way adapter, thermometer, and condenser), and a stopper for future additions. The contents of the flask were heated slowly (so that the temperature of the distillate did not exceed 100° C.) to 230° C., and held until the acid number dropped to 3 mg KOH/g resin. The temperature was then reduced to 170° C., and nadic anhydride (750.0 g) was added to the flask and held for 1 hour, after which the packed column was removed and replaced with a Dean-Stark trap (topped with a condenser) filled with xylene in preparation for an azeotrope reflux. The temperature was then raised to 200° C. (or as restricted by reflux) and held until the acid number dropped below 10 mg KOH/g resin. At this point, the resin was cooled to 170° C. and cut to 60% Solids with AROMATIC 150 solvent (1317.0 g). The resulting resin was stirred until uniform and discharged. The resulting polyester prepolymer had an acid number of 46.1

504.6 grams of the resin was transferred to a 1-liter flask fitted with a mechanical stirrer, a thermocouple, a condenser, and a stopper for sampling or additions. The contents of the flask were heated to 130° C. and Phthalic Anhydride (33.5 g) was added to the flask in three parts with a 20-minute hold between each addition. Following the final addition, AROMATIC 150 (14.7 g) was added to the flask. At this point, the resin was heated to 145° C. and held until the acid number dropped below 47.1 mg KOH/g resin. Tetramethyl bisphenol F diglycidyl ether (28.9 g) and tributylamine (1.08 g) were added to the flask, and the contents were heated to 160° C. under a nitrogen atmosphere. After a 3-hour hold at 160° C., cyclohexanone (218.4 g) was added to achieve a 45% solids solution, and the resin was cooled to room temperature. The final polyester copolymer had an Mn of 4,170.

An organic solvent-based coating composition was prepared in the same matter as Sample A that included 75% by solids weight of the resulting resin with 25% by solids weight of Bakelite PF 6470LB phenolic crosslinker, available from Hexion. The coating composition was approximately 39.5% solids.

Comparative Sample C: A coating composition that includes a polyester derived from nadic anhydride monomer. The coating composition was prepared according to the following procedure. Cyclohexane-1,4-dimethanol (626.2 g of a 90% solution in water), 2-methyl-1,3-propanediol (325.8 g), terephthalic acid (158.1 g), isophthalic acid (315.8 g), and dibutyltin oxide (1.9 g) were charged to a 5-liter. 4-neck round bottom flask fitted with a mechanical stirrer, a thermocouple, a packed column (topped with a Dean-Stark trap and condenser), and a stopper for future additions. The contents of the flask were heated slowly (so that the temperature of the distillate did not exceed 100° C.) to 232° C. under a nitrogen atmosphere, and held until the acid number dropped to 1.0 mg KOH/g resin. The temperature was then reduced to 170° C., and nadic anhydride (585.0 g) was added to the flask. Following a 1-hour hold at 170° C., xylene (154.9 g) was added to the flask, the packed column was removed, and the trap was pre filled with xylene in preparation for an azeotrope reflux. The temperature was then raised to 220° C. (or as restricted by reflux) and held until the acid number dropped below 2 mg KOH/g resin. At this point, the resin was cooled to 170° C. and cut to 60% solids with cyclohexanone (1032.5 g). The resulting resin was stirred until uniform and 2697.0 grams were transferred to a 5-liter flask fitted with a mechanical stirrer, a thermocouple, a condenser, and a stopper for sampling or additions. Pyromellitic dianhydride (86.9 g) was added to the flask, and the contents were heated to 120° C. under a nitrogen atmosphere. After a 4-hour hold at 120° C., cyclohexanone (222.0 g) and AROMATIC 150 solvent (1149.0 g) were added to achieve a 41% solids solution, and the resin was cooled to room temperature. The final polyester copolymer had an Mn of 4,580.

An organic-solvent-based coating composition was prepared analogous to Sample A and Comparative Sample B that included 75% by solids weight of the resulting resin with 25% by solids weight of Bakelite PF 6470LB phenolic crosslinker, available from Hexion. The coating composition was approximately 39.5% solids. Sample A, Comparative Example B, and Comparative Example C were formulated to be identical except for the polyester copolymer.

### Example 4: Cured Coating Compositions

The coating compositions of Example 3 were applied to a metal substrate and cured. The coating compositions were applied to 0.20 73 #lab grade electrolytic tinplate at 4.4-5.1 msi (milligrams per square inch, equivalent to 6.8-7.9 grams per square meter) and cured for 10 minutes at a 400ºF (204 C) peak metal temperature (PMT) in a gas-fired force draft oven box to form cured coatings. The results of coating performance tests performed on the cured coatings are shown in Table 1.

TABLE 1

| | | Coating of | Coating of |
|---|---|---|---|
| | Coating of | Comparative | Comparative |
| Test | Sample A | Sample B | Sample C |
| Dry Adhesion | 10 | 10 | 10 |
| Crazing¹ | Trace | Trace | Trace |
| MEK Resistance (double rubs) | >100 | 55 | >100 |
| Water Retort strips - 90 @ 250° | | | |
| F.² | | | |
| Blush (L/V) | 10/10 | 10/10 | 10/10 |
| Adhesion (L/V) | 10/10 | 10/10 | 10/10 |
| 2% Salt Retort strips- 90′ @ | | | |
| 250° F.³ | | | |
| Blush (L/V) | 9/10 | 5/10 | 10/10 |
| Adhesion (L/V) | 10/10 | 0/10 | 0/10 |
| Tg cured film (° C.) | about 100 | about 85 | about 100 |

¹Crazing was assessed using 26 in pounds (lbs)/2 lb wt. - direct/reverse impact on flat panel
²90 minutes at 250° F. (121° C.) and 15 psi pressure (~1.05 kg/cm²) in deionized water. L/V = Liquid/Vapor.
³90 minutes at 250° F. (121° C.) and 15 psi pressure (~1.05 kg/cm²) in 2% salt deionized water. L/V = Liquid/Vapor.

### EMBODIMENTS

Embodiment 1 is a polymer suitable for use in a coating composition comprising a polyester copolymer preferably having hydroxyl groups pendant to the backbone of the copolymer; wherein the polyester copolymer is derived from reactants comprising a Tg-increasing monomer and a backbone-reactivity increasing monomer.

Embodiment 2 is a coated metal substrate comprising: a metal substrate; and a coating on at a portion of the metal substrate; wherein the coating is formed from a coating composition comprising: a polyester copolymer preferably having hydroxyl groups pendant to the backbone of the copolymer; wherein the polyester copolymer is derived from a Tg-increasing monomer and a backbone-reactivity increasing monomer.

Embodiment 3 is a method of making a coated metal substrate comprising: providing a metal substrate; applying a coating composition on at least a portion of the metal substrate prior to or after forming the metal substrate into a food or beverage container or a portion of a food or beverage container; and curing the coating composition to form a coating; wherein the coating composition comprises: a polyester copolymer preferably having hydroxyl groups pendant to the backbone of the copolymer; wherein the polyester copolymer is derived from a Tg-increasing monomer and a backbone-reactivity increasing monomer.

Embodiment 4 is a coated metal article comprising: a metal substrate; and a coating formed from a coating composition comprising: a polyester copolymer preferably having hydroxyl groups pendant to the backbone of the copolymer; wherein the polyester copolymer is derived from a Tg-increasing monomer and a backbone-reactivity increasing monomer; and wherein the coated metal article is suitable for use as a food or beverage container.

Embodiment 5 is a coating composition comprising: a polyester copolymer preferably having hydroxyl groups pendant to the backbone of the copolymer; wherein the polyester copolymer is derived from a Tg-increasing monomer and a backbone-reactivity increasing monomer; optionally a carrier; optionally a lubricant; optionally a wetting additive; and optionally a defoamer.

Embodiment 6 is the coated metal substrate, method, or coated article of any preceding embodiment, wherein the metal substrate is aluminum.

Embodiment 7 is the coated metal substrate, method, or coated article of any preceding embodiment, wherein the metal substrate is steel.

Embodiment 8 is the coated metal substrate, method, or coated article of any preceding embodiment, wherein the metal substrate is chrome-treated steel.

Embodiment 9 is the coated metal substrate, method, or coated article of any preceding embodiment, wherein the metal substrate is electrolytic tinplate steel.

Embodiment 10 is the coated metal substrate, method, or coated article of any preceding embodiment, wherein the metal substrate is tin-free steel.

Embodiment 11 is the polymer, coated metal substrate, method, coated metal article, or coating composition, of any preceding embodiment, wherein the polyester copolymer is derived from ingredients comprising a polyester prepolymer and a diepoxide resin.

Embodiment 12 is the polymer, coated metal substrate, method, coated metal article, or coating composition, of any preceding embodiment, wherein the polyester copolymer is a polyester ether copolymer, preferably a polyester ether block copolymer.

Embodiment 13 is the polymer, coated metal substrate, method, coated metal article, or coating composition, of any preceding embodiment, wherein the polyester copolymer is derived from ingredients comprising a diepoxide resin.

Embodiment 14 is the polymer, coated metal substrate, method, coated metal article, or coating composition, of any preceding embodiment, wherein the polyester copolymer is a polyester ether block copolymer derived from ingredients comprising a diglycidyl ether.

Embodiment 15 is the polymer, coated metal substrate, method, coated metal article, or coating composition, of any preceding embodiment, wherein the diepoxide resin is derived from a Tg-increasing monomer.

Embodiment 16 is the polymer, coated metal substrate, method, coated metal article, or coating composition, of any preceding embodiment, wherein the Tg-increasing monomer is a diol.

Embodiment 17 is the polymer, coated metal substrate, method, coated metal article, or coating composition, of any preceding embodiment, wherein the polyester prepolymer is derived from a Tg-increasing monomer.

Embodiment 18 is the polymer, coated metal substrate, method, coated metal article, or coating composition, of any preceding embodiment, wherein the diepoxide resin is provided by an epoxide component that has a mole ratio of epoxy groups to expoxide component of at least 1.2:1, at least 1.6:1, or at least 1.7:1 equivalents of epoxy groups per mole of epoxide component, epoxide component has a mole ratio of epoxy groups to diepoxide resin of at least 1.2:1, at least 1.6:1, or at least 1.7:1 to at most 2.2:1.

Embodiment 19 is the polymer, coated metal substrate, method, coated metal article, or coating composition, of any preceding embodiment, wherein the diepoxide resin is provided by an epoxide component that has a mole ratio of epoxy groups to epoxide component of at most 2.2:1, at most 2.1:1, or at most 2:1.

Embodiment 20 is the polymer, coated metal substrate, method, coated metal article, or coating composition, of any preceding embodiment, wherein the diepoxide resin is derived from a monomer (e.g., a diol) that includes a polycyclic structural unit.

Embodiment 21 is the polymer, coated metal substrate, method, coated metal article, or coating composition, of any preceding embodiment, wherein the diepoxide is derived from a monomer (e.g., a diol) having a monocyclic group with less than six members in a ring.

Embodiment 22 is the polymer, coated metal substrate, method, coated metal article, or coating composition, of any preceding embodiment, wherein the diepoxide resin includes a polycyclic (e.g., a bicyclic or tricyclic) structural group.

Embodiment 23 is the polymer, coated metal substrate, method, coated metal article, or coating composition, of any preceding embodiment, wherein the diepoxide resin includes a monocyclic group with less than six members in a ring.

Embodiment 24 is the polymer, coated metal substrate, method, coated metal article, or coating composition, of any preceding embodiment, wherein the diepoxide resin comprises a diepoxide of tetramethyl bisphenol F, more preferably a tetramethyl bisphenol F diglycidyl ether.

Embodiment 25 is the polymer, coated metal substrate, method, coated metal article, or coating composition, of any preceding embodiment, wherein the diepoxide resin comprises a diepoxide of a tetramethyl cyclobutanediol, more preferably a diglycidyl ether of a tetramethyl cyclobutanediol.

Embodiment 26 is the polymer, coated metal substrate, method, coated metal article, or coating composition, of any preceding embodiment, wherein the diepoxide resin comprises a diepoxide of a substituted or unsubstituted pentaspiroglycol, more preferably a diglycidyl ether of 3,9-bis(1,1-dimethyl-2-hydroxyethyl)-2,4,8,10-tetraoxaspiro[5.5]undecane.

Embodiment 27 is the polymer, coated metal substrate, method, coated metal article, or coating composition, of any preceding embodiment, wherein the polyester prepolymer is prepared by reacting polymerized monomers for the polyester prepolymer with an anhydride (e.g., the final polyester prepolymer is formed by end-capping an intermediate polyester prepolymer on at least one, and preferably both, ends of the polymer backbone).

Embodiment 28 is the polymer, coated metal substrate, method, coated metal article, or coating composition, of any preceding embodiment, wherein the backbone of the polyester prepolymer is terminated on at least one end by a carboxyl group.

Embodiment 29 is the polymer, coated metal substrate, method, coated metal article, or coating composition, of any preceding embodiment, wherein the backbone of the polyester prepolymer is terminated on both ends by carboxyl groups.

Embodiment 30 is the polymer, coated metal substrate, method, coated metal article, or coating composition, of any preceding embodiment, wherein the polyester prepolymer has a number average molecular weight (Mn) of at least about 400, at least about 750, at least about 1250, or at least about 1800.

Embodiment 31 is the polymer, coated metal substrate, method, coated metal article, or coating composition, of any preceding embodiment, wherein the polyester prepolymer has a number average molecular weight (Mn) of less than about 7000, less than about 5000, less than about 3500, or less than about 2500.

Embodiment 32 is the polymer, coated metal substrate, method, coated metal article, or coating composition, of any preceding embodiment, wherein the polyester prepolymer has a glass transition temperature (Tg) of at least 20° C., at least 25° C., at least 30° C., at least 50° C., at least 60° C., or at least 70° C.

Embodiment 33 is the polymer, coated metal substrate, method, coated metal article, or coating composition, of any preceding embodiment, wherein the polyester prepolymer has an acid number of at least 10, at least 20, at least 30, or at least 40 mg KOH/g resin.

Embodiment 34 is the polymer, coated metal substrate, method, coated metal article, or coating composition or any preceding embodiment, wherein the Tg-increasing monomer comprises a monomer having a polycyclic group (e.g., bicyclic or tricyclic or higher) or a cyclic group that has less than six atoms in a ring.

Embodiment 35 is the polymer, coated metal substrate, method, coated metal article, or coating composition of any preceding embodiment, wherein the rings of the polycyclic group or the cyclic group are cycloaliphatic rings.

Embodiment 36 is the polymer, coated metal substrate, method, coated metal article, or coating composition of any preceding embodiment, wherein the Tg-increasing monomer comprises one or more of a furandicarboxylic acid, preferably 2,5-furandicarboxylic acid, a furandimethanol, or a diepoxide thereof.

Embodiment 37 is the polymer, coated metal substrate, method, coated metal article, or coating composition of any preceding embodiment, wherein the Tg-increasing monomer comprises one or more of an isosorbide, a substituted variant thereof, or a diepoxide of isosorbide.

Embodiment 38 is the polymer, coated metal substrate, method, coated metal article, or coating composition of any preceding embodiment, wherein the Tg-increasing monomer comprises one or more of a cyclobutanediol.

Embodiment 39 is the polymer, coated metal substrate, method, coated metal article, or coating composition of any preceding embodiment, wherein the Tg-increasing monomer comprises 2.2,4,4-tetramethyl-1,3-cyclobutanediol or a diepoxide thereof.

Embodiment 40 is the polymer, coated metal substrate, method, coated metal article, or coating composition of any preceding embodiment, wherein the Tg-increasing monomer comprises one or more of tricyclodecane dimethanol, a substituted variant thereof, or a diepoxide thereof.

Embodiment 41 is the polymer, coated metal substrate, method, coated metal article, or coating composition of any preceding embodiment, wherein the Tg-increasing monomer comprises nadic acid, nadic anhydride, a substituted variant thereof, or a combination thereof.

Embodiment 42 is the polymer, coated metal substrate, method, coated metal article, or coating composition of any preceding embodiment, wherein the Tg-increasing monomer comprises naphthalene dicarboxylic acid or a substituted variant thereof.

Embodiment 43 is the polymer, coated metal substrate, method, coated metal article, or coating composition, of any preceding embodiment, wherein the Tg-increasing monomer is a diol comprising a polycyclic group.

Embodiment 44 is the polymer, coated metal substrate, method, coated metal article, or coating composition, of any preceding embodiment, wherein the Tg-increasing monomer is a diol comprising a monocyclic group that has less than six members in a ring.

Embodiment 45 is the polymer, coated metal substrate, method, coated metal article, or coating composition, of any preceding embodiment, wherein the Tg-increasing monomer is a diol comprising an aromatic group.

Embodiment 46 is the polymer, coated metal substrate, method, coated metal article, or coating composition, of any preceding embodiment, wherein the Tg-increasing monomer is a diol comprising a highly branched aliphatic group (e.g., includes two or more branch points and less than 20 carbon atoms, less than 15 carbon atoms, less than 12 carbon atoms, less than 10 carbon atoms, or less than 9 carbon atoms).

Embodiment 47 is the polymer, coated metal substrate, method, coated metal article, or coating composition of any preceding embodiment, wherein the Tg-increasing monomer comprises Pentaspiroglycol.

Embodiment 48 is the polymer, coated metal substrate, method, coated metal article, or coating composition of any preceding embodiment, wherein the Tg-increasing monomer comprises tetramethylcylobutanediol.

Embodiment 49 is the polymer, coated metal substrate, method, coated metal article, or coating composition of any preceding embodiment, wherein the Tg-increasing monomer comprises 2.2,4,4-tetramethyl-1,3-cyclobutanediol.

Embodiment 50 is the polymer, coated metal substrate, method, coated metal article, or coating composition of any preceding embodiment, wherein the Tg-increasing monomer comprises 2.2,4,4-tetramethyl pentane-1,3-diol.

Embodiment 51 is the polymer, coated metal substrate, method, coated metal article, or coating composition of any preceding embodiment, wherein the backbone-reactivity increasing monomer comprises a diepoxide.

Embodiment 52 is the polymer, coated metal substrate, method, coated metal article, or coating composition of any preceding embodiment, wherein the backbone-reactivity increasing monomer comprises a diepoxide with a tetramethyl bisphenol F structural unit.

Embodiment 53 is the polymer, coated metal substrate, method, coated metal article, or coating composition of any preceding embodiment, wherein the polyester prepolymer is derived from a monomer having an anhydride structural unit.

Embodiment 54 is the polymer, coated metal substrate, method, coated metal article, or coating composition of any preceding embodiment, wherein the polyester prepolymer is derived from a monomer having a structural unit comprising a phthalic anhydride or nadic anhydride.

Embodiment 55 is the polymer, coated metal substrate, method, coated metal article, or coating composition of any preceding embodiment, wherein the polyester copolymer is derived from ingredients comprising at least 1 weight percent and at most 40 weight percent nadic anhydride based on the weight of solid ingredients of the polyester copolymer.

Embodiment 56 is the polymer, coated metal substrate, method, coated metal article, or coating composition of any preceding embodiment, wherein the polyester prepolymer is at least partially unsaturated.

Embodiment 57 is, the polymer, coated metal substrate, method, coated metal article, or coating composition of any preceding embodiment, wherein the polyester prepolymer has an iodine number of at least 5, at least 10, at least 20, or at least 50 g iodine per gram of polyester prepolymer.

Embodiment 58 is the polymer, coated metal substrate, method, coated metal article, or coating composition of any preceding embodiment, wherein the polyester copolymer is at least partially unsaturated.

Embodiment 58 is the polymer, coated metal substrate, method, coated metal article, or coating composition of any preceding embodiment, wherein the polyester copolymer has a Mn that is at most about 10,000, at most about 8,000, or at most about 6,000.

Embodiment 60 is the polymer, coated metal substrate, method, coated metal article, or coating composition of any preceding embodiment, wherein the polyester copolymer has a Mn that is at least about 1,500, at least about 2,500, at most about 4,500, or at most about 5,500.

Embodiment 61 is the polymer, coated metal substrate, method, coated metal article, or coating composition of any preceding embodiment, wherein the polyester copolymer has a hydroxyl number of at least about 1, at least about 5, or at least about 10 g KOH per g polyester copolymer.

Embodiment 62 is the polymer, coated metal substrate, method, coated metal article, or coating composition of any preceding embodiment, wherein the polyester copolymer has a hydroxyl number of at most about 180, at most about 150, or at most about 100 g KOH per g polyester copolymer.

Embodiment 63 is the polymer, coated metal substrate, method, coated metal article, or coating composition of any preceding embodiment, wherein the polyester copolymer is suitable for use in a solvent-based coating composition and wherein acid number of the polyester copolymer is at most about 40.

Embodiment 64 is the polymer, coated metal substrate, method, coated metal article, or coating composition of any preceding embodiment, wherein the polyester copolymer is suitable for use in a solvent-based coating composition and wherein the acid number of the polyester copolymer is at most about 30.

Embodiment 65 is the polymer, coated metal substrate, method, coated metal article, or coating composition of any preceding embodiment, wherein the polyester copolymer is suitable for use in a solvent-based coating composition and wherein the acid number of the polyester copolymer is at most about 20.

Embodiment 66 is the polymer, coated metal substrate, method, coated metal article, or coating composition of any preceding embodiment, wherein the polyester copolymer is suitable for use in a solvent-based coating composition and wherein the acid number of the polyester copolymer is at least about 0.

Embodiment 67 is the polymer, coated metal substrate, method, coated metal article, or coating composition of any preceding embodiment, wherein the polyester copolymer is dispersible in an aqueous carrier, and wherein the acid number of the polyester copolymer is at most about 200.

Embodiment 68 is the polymer, coated metal substrate, method, coated metal article, or coating composition of any preceding embodiment, wherein the polyester copolymer is dispersible in an aqueous carrier, and wherein the acid number of the polyester copolymer is at most about 70.

Embodiment 69 is the polymer, coated metal substrate, method, coated metal article, or coating composition of any preceding embodiment, wherein the polyester copolymer is dispersible in an aqueous carrier, and wherein the acid number of the polyester copolymer is at most about 40.

Embodiment 70 is the polymer, coated metal substrate, method, coated metal article, or coating composition of any preceding embodiment, wherein the polyester copolymer is dispersible in an aqueous carrier, and wherein the acid number of the polyester copolymer is at least about 15.

Embodiment 71 is the polymer, coated metal substrate, method, coated metal article, or coating composition of any preceding embodiment, wherein the polyester copolymer is at least partially neutralized by reaction with a base (preferably, a primary, secondary, or tertiary amine), and wherein the polyester copolymer is dispersible in an aqueous carrier.

Embodiment 72 is the polymer, coated metal substrate, method, coated metal article, or coating composition of any preceding embodiment, wherein the Tg-increasing monomer is at least about 1, at least about 15, at least about 30, or at least 50 weight percent of the reactants used to generate the polyester copolymer.

Embodiment 73 is the polymer, coated metal substrate, method, coated metal article, or coating composition of any preceding embodiment, wherein the Tg-increasing monomer is at least about 5, at least about 7, at least about 10, or at least about 15 weight percent of the reactants used to generate the polyester copolymer.

Embodiment 74 is the polymer, coated metal substrate, method, coated metal article, or coating composition of any preceding embodiment, wherein the epoxide component has a mole ratio of epoxy groups to diepoxide resin of at least 1.2:1, at least 1.6:1, or at least 1.7:1 to at most 2.2:1, at most 2.1:1, or at most 2:1 equivalents of epoxy groups per mole of epoxide component.

Embodiment 75 is the polyester copolymer of any preceding embodiment, wherein the polyester copolymer is dispersible in water.

Embodiment 76 is the polyester copolymer of any preceding embodiment, wherein the polyester copolymer is dispersible in an organic solvent.

Embodiment 77 is the polyester copolymer of any preceding embodiment, wherein the polyester copolymer is completely free, essentially free, or substantially free of each of bisphenol-A, bisphenol-F, and bisphenol-S.

Embodiment 78 is the polymer, coated metal substrate, method, coated metal article, or coating composition of any preceding embodiment, wherein the polyester copolymer includes a plurality of —CH₂—CH(OH)—CH₂— and/or —CH₂— CH₂—CH(OH)— segments within the backbone of the polymer.

Embodiment 79 is the polymer, coated metal substrate, method, coated metal article, or coating composition of any preceding embodiment, wherein the structural unit provided by the diepoxide is independently joined to adjacent structural units of the polyester copolymer backbone by a CH₂CH(OH)—CH₂— or a —CH₂— CH₂—CH(OH)— segment.

Embodiment 80 is the polymer, coated metal substrate, method, coated metal article, or coating composition of any preceding embodiment, wherein the polyester copolymer has a Tg of at least about 30° ° C., at least about 40° C., at least about 50° C., at least about 55° C., at least about 60° C., at least about 65° C., or at least about 70° C.

Embodiment 81 is the polymer, coated metal substrate, method, coated metal article, or coating composition of any preceding embodiment, wherein the polyester copolymer has a Tg of at most about 130° C., at most about 100° C., at most about 80° C., at most about 75° C., or at most about 70° C.

Embodiment 82 is the polymer, coated metal substrate, method, coated metal article, or coating composition of any preceding embodiment, wherein the polyester copolymer is derived from ingredients comprising terephthalic acid or isophthalic acid or a combination thereof.

Embodiment 83 is the polymer, coated metal substrate, method, coated metal article, or coating composition of any preceding embodiment, wherein the polyester copolymer is derived from ingredients comprising 2-Methyl-2,4-pentanediol, Cyclohexane-1,4-dimethanol, or a combination thereof.

Embodiment 84 is the coated metal substrate, method, coated metal article, or coating composition of any preceding embodiment, wherein the coating composition is solvent-based.

Embodiment 85 is the coated metal substrate, method, coated metal article, or coating composition of any preceding embodiment, wherein the coating composition is water-based.

Embodiment 86 is the coated metal substrate, method, coated metal article, or coating composition of any preceding embodiment, wherein the coating composition is a powder coating composition.

Embodiment 87 is the coated metal substrate, method, coated metal article, or coating composition of any preceding embodiment, wherein the polyester copolymer is at least about 10 weight percent, at least about 20 weight percent, or at least about 50 weight percent, or at least about 70 weight percent of the total resin solids of the coating composition.

Embodiment 88 is the coated metal substrate, method, coated metal article, or coating composition of any preceding embodiment, wherein the polyester copolymer is at most about 25 weight percent, at most about 50 weight percent, at most about 75 weight percent of the total resin solids, or at most about 85 weight percent of the total resin solids of the coating composition.

Embodiment 89 is the coated metal substrate, method, coated metal article, or coating composition of any preceding embodiment, wherein the coating composition comprises zinc oxide.

Embodiment 90 is the coated metal substrate, method, coated metal article, or coating composition of any preceding embodiment, wherein the coating composition comprises a crosslinker.

Embodiment 91 is the coated metal substrate, method, coated metal article, or coating composition of any preceding embodiment, wherein the crosslinker is an aminoplast, phenoplast, blocked isocyanate, beta-hydroxyalkyl amide, benzoxazine, carbonyl dicaprolactam, oxazoline, or combinations thereof.

Embodiment 92 is the coated metal substrate, method, coated metal article, or coating composition of any preceding embodiment, wherein the crosslinker is a phenoplast crosslinker.

Embodiment 93 is the coated metal substrate, method, coated metal article, or coating composition of any preceding embodiment, wherein the crosslinker is present in an amount of at most about 50 weight percent, at most about 30 weight percent, or at most about 15 weight percent of the total resin solids in the coating composition.

Embodiment 94 is the coated metal substrate, method, coated metal article, or coating composition of any preceding embodiment, wherein the crosslinker is present in an amount of at least about 0.1 weight percent, at least about 1 weight percent, or at least about 10 weight percent of the total resin solids in the coating composition.

Embodiment 95 is the coated metal substrate, method, coated metal article, or coating composition of any preceding embodiment, wherein the coating composition comprises a lubricant.

Embodiment 96 is the coated metal substrate, method, coated metal article, or coating composition of any preceding embodiment, wherein the coating composition comprises a lubricant and wherein the lubricant is present in an amount of at least 0.1 weight percent based on the total weight of solids in the coating composition.

Embodiment 97 is the coated metal substrate, method, coated metal article, or coating composition of any preceding embodiment, wherein the coating composition comprises a lubricant and wherein the lubricant is present in an amount of at most about 3 weight percent or at most about 2 weight percent or at most about 1 weight percent based on the total weight of solids in the coating composition.

Embodiment 98 is the coated metal substrate, method, coated metal article, or coating composition of any preceding embodiment, wherein the coating composition comprises an inorganic additive.

Embodiment 99 is the coated metal substrate, method, coated metal article, or coating composition of embodiment 95, wherein the inorganic additive is titanium dioxide.

Embodiment 100 is the coated metal substrate, method, coated metal article, or coating composition of embodiment 96, wherein the titanium dioxide is present in an amount of no greater than 70 wt. percent, more preferably no greater than 50 wt. percent and even more preferably no greater than 40 wt. %, based on the total weight of solids in the coating composition.

Embodiment 101 is the coated metal substrate, method, coated metal article, or coating composition of any preceding embodiment, wherein the coating composition comprises a wetting additive.

Embodiment 102 is the coated metal substrate, method, coated metal article, or coating composition of any preceding embodiment, wherein the coating composition comprises a defoamer.

Embodiment 103 is the coated metal substrate, method, or coated metal article of any preceding embodiment, wherein the coating has an average thickness after curing of at most about 20 microns.

Embodiment 104 is, the coated metal substrate, method, or coated metal article of any preceding embodiment, wherein the coating has an average thickness after curing of at most about 10 microns.

Embodiment 105 is coated metal substrate, method, coated metal article, or coating composition of any preceding embodiment, wherein the coating composition includes at least about 15 weight percent, at least about 30 weight percent, at least about 35 weight percent, or at least about 40 weight percent of total coating solids.

Embodiment 106 is the coated metal substrate, method, coated metal article, or coating composition of any preceding embodiment, wherein the coating composition includes at most about 70 weight percent, or at most about 65 weight percent of total coating solids.

Embodiment 107 is the method or coated metal article of any preceding embodiment, wherein the coating is present on the interior surface of the food or beverage container.

Embodiment 108 is the method or coated metal article of any preceding embodiment, wherein the coating is present on the exterior surface of the food or beverage container.

Embodiment 109 is the method or coated metal article of any preceding embodiment, wherein the coating present on the exterior surface of the food or beverage container includes a colorant.

Embodiment 110 is the method or coated metal article of any preceding embodiment, wherein the coating is present on the exterior surface of the food or beverage container and the interior surface of the food or beverage container.

Embodiment 111 is the method or coated metal article of any preceding embodiment, wherein the food or beverage container is a two-piece can.

Embodiment 112 is the method or coated metal article of any preceding embodiment, wherein the food or beverage container is a three-piece can.

Embodiment 113 is the method or coated metal article of any preceding embodiment, wherein the food or beverage container is a metal cup.

Embodiment 114 is the method or coated metal article of any preceding embodiment, wherein the coating is present on a metal cap.

Embodiment 115 is the method or coated metal article of any preceding embodiment, wherein the metal cap is an end cap or a lug cap.

Embodiment 116 is the method or coated metal article of any preceding embodiment, wherein the coating composition is present on the interior surface of a lug cap.

Embodiment 117 is the method or coated metal article of any preceding embodiment, wherein an organosol coating is present on the coating composition and a plastisol ring is present on the organosol coating.

Embodiment 118 is the method or coated metal article of any preceding embodiment, wherein the coating is present at an average dry thickness of at least 1, at least 2, or at least 3 milligrams per square inch.

Embodiment 119 is the method or coated metal article of any preceding embodiment, wherein the coating is present at an average dry thickness of at most 20, preferably at most 15 milligrams per square inch.

What is claimed is:

1-24. (canceled)

25. A coating composition comprising:
a polyester ether copolymer having hydroxyl groups pendant to the backbone of the copolymer;
wherein the polyester ether copolymer is derived from ingredients including a Tg-increasing diol and a diepoxide resin;
wherein the Tg-increasing diol includes a polycyclic group, a monocyclic group having less than six members in a ring, an aromatic group, or a branched aliphatic group of 20 carbons or less with two or more branch points in the aliphatic structure, or combinations thereof;
optionally, one or more of a carrier, a lubricant, a wetting additive, or a defoamer; and
wherein the coating is a food-contact coating for food and beverage applications.

26. The coating composition of claim 25,
wherein the Tg-increasing diol includes one or more structural groups having (i) more than one aliphatic or aromatic ring, wherein two or more rings share at least one atom such that the rings are fused, bridged, or spiro with respect to each other, or (ii) a monocyclic group that has less than six atoms in a ring.

27. The coating composition of claim 26,
wherein the he Tg-increasing diol includes one or more structural groups having more than one cycloaliphatic ring, wherein the rings share at least one atom such that the rings are fused, bridged, or spiro with respect to each other.

28. The coating composition of claim 25,
wherein the Tg-increasing diol comprises a pentaspiroglycol (e.g., 3,9-bis(1,1-dimethyl-2-hydroxyethyl)-2,4,8,10-tetraoxaspiro[5.5]undecane), a cyclobutanedimethanol (e.g., 2,2,4,4-tetramethyl-1,3-cyclobutanediol), a tricyclodecanedimethanol (e.g., 4,8-Bis(hydroxymethyl)tricyclo[5.2.1.02,6]decane), a furan dimethanol (e.g., 2,5-furandimethanol), an isosorbide (e.g., ((3R,3aR,6S,6aR)-Hexahydrofuro[3,2-b]furan-3,6-diol), a diol including a norbornene group (e.g., a norbornene dimethanol), or a combination thereof.

29. The coating composition of claim 25,
wherein the polyester ether copolymer is derived from ingredients comprising a polyester prepolymer and a diepoxide resin, and wherein the polyester prepolymer is derived from ingredients including the Tg-increasing diol.

30. The coating composition of claim 25,
wherein the diepoxide resin is derived from ingredients including a Tg-increasing diol, wherein the Tg-increasing diol includes a polycyclic group, a monocyclic group having less than six members in a ring, an aromatic group, or a branched aliphatic group of 20 carbons or less with two or more branch points in the aliphatic structure, or combinations thereof.

31. The coating composition of claim 25,
wherein the diepoxide resin includes a polycyclic structural group, a monocyclic group with less than six members in a ring, or combinations thereof.

32. The coating composition of claim 31,
wherein the diepoxide resin comprises a diglycidyl ether of tetramethyl bisphenol F, a diglycidyl ether of a tetramethyl cyclobutanediol, a diglycidyl ether of a substituted or unsubstituted pentaspiroglycol, a diglycidyl ether of a substituted or unsubstituted tricyclodecane dimethanol, or a combination thereof.

33. The coating composition of claim 25,
wherein the polyester ether copolymer, is formed from ingredients including a dicarboxylic acid, or an anhydride or alkyl ester thereof.

34. The coating composition of claim 33,
wherein the polyester prepolymer is prepared by reacting polymerized monomers for the polyester prepolymer with an anhydride.

35. The coating composition of claim 25,
wherein the backbone of the polyester prepolymer is terminated on at least one end by a carboxyl group.

36. The coating composition of claim 25,
wherein the backbone of the polyester prepolymer is terminated on both ends by carboxyl groups.

37. The coating composition of claim 25,
wherein the polyester prepolymer has a number average molecular weight (Mn) of at least about 400 to less than about 7,000.

38. The coating composition of claim 25,
wherein the polyester prepolymer has a glass transition temperature (Tg) of at least 20° C.

39. The coating composition of claim 25,
wherein the polyester ether copolymer has a Tg of at least about 50° C. and at most about 130° C.

40. The coating composition of claim 25,
wherein the polyester prepolymer has an acid number of at least 10 mg KOH per gram of the polyester prepolymer.

41. The coating composition of claim 25,
wherein the Tg increasing diol is at least about 1 weight percent of the reactants used to generate the polyester ether copolymer.

42. The coating composition of claim 25,
wherein the coating composition includes at least about 10 weight percent of the polyester ether copolymer based on total solids.

43. The coating composition of claim 25,
wherein the coating composition includes at least 1 weight percent of a hydroxyl-reactive crosslinker based on total resin solids.

44. The coating composition of claim 25,
wherein the coating composition is substantially free of each of bisphenol A, bisphenol F, and bisphenol S.

45. The coating composition of claim 25,
wherein when applied to 0.20 73% lab grade electrolytic tinplate at 4.4-5.1 milligrams per square inch and cured for 10 minutes at a 400° F. peak metal temperature in a gas-fired force draft oven, the resulting cured coating exhibits:
dry adhesion of at least 10 measured according to the test method described herein; and
following retort in deionized water for 90 minutes at 250ºF and 15 psi, a blush rating of 10/10 measured according to the test method disclosed herein and an adhesion rating of 10/10 measured according to the test method described herein; and
following retort in 2% salt solution in water for 90 minutes at 250ºF and 15 psi, a blush rating of at least 9/10 measured according to the test method disclosed herein and an adhesion rating of at least 3/10 measured according to the test method described herein; and
MEK resistance measured according to the test method described herein of at least 100 double rubs; and
and no more than a trace level of crazing as measured according to the test method described herein.
a Tg of more than 90° C.;

46. The coating composition of claim 25, applied on a metal substrate prior to or after forming the metal substrate into a food or beverage container or a portion thereof.
